(19) United States
(12) Patent Application Publication
(10) Pub. No.: US 2017/0208151 A1
(43) Pub. Date: Jul. 20, 2017

(54) SYSTEMS AND METHODS INVOLVING DIAGNOSTIC MONITORING, AGGREGATION, CLASSIFICATION, ANALYSIS AND VISUAL INSIGHTS

(71) Applicant: Reylabs Inc., San Jose, CA (US)

(72) Inventors: Reynaldo Gil, Campbell, CA (US); Gabriel Paunescu, Bucuresti (RO)

(21) Appl. No.: 15/477,500

(22) Filed: Apr. 3, 2017

Related U.S. Application Data
(63) Continuation of application No. PCT/US2015/053882, filed on Oct. 2, 2015.
(60) Provisional application No. 62/059,114, filed on Oct. 2, 2014.
(60) Provisional application No. 62/059,117, filed on Oct. 2, 2014.
(60) Provisional application No. 62/059,118, filed on Oct. 2, 2014.

(51) Int. Cl. H04L 29/08; G06F 9/30

(52) U.S. Cl. CPC H04L 67/34; H04L 67/1091; H04L 67/1097; H04L 67/12; G06F 9/30

(57) ABSTRACT

Certain systems and methods herein are directed to features of diagnostic monitoring, accessing and/or improving data management, classification, analysis and data visualization of complex multi-channel parallel data streams. Parallel data streams can indexed and enhanced to high fidelity using any combination of inputs used from any source to analyze the efficiency of a building, configuration of machinery or a business process including aspects involving loT (the Internet of things). Parallel data streams are transformed in realtime into actionable views or exportable formats for machine-based learning or expert analysis. For example, some embodiments may include ways to measure occupant comfort, ways to conserve energy in heating and cooling linear asset networks, measure the efficiency of linear assets for energy and water delivery and consumption, improve any machine, data center, communications equipment efficiency by increasing maintenance or energy/water efficiency and many others.

### CROSS-REFERENCE TO RELATED APPLICATIONS

This application claims benefit/priority of PCT/US15/53882 filed 2 Oct. 2015 which in turn claims priority to U.S. provisional patent application No. 62/059,114, filed 2 Oct. 2014; U.S. provisional patent application No. 62/059,117, filed 2 Oct. 2014; and U.S. provisional patent application No. 62/059,118, filed 2 Oct. 2014, all of which are incorporated herein by reference in their entireties.

### FIELD

This application relates to the field of mobile instrumentation, distributed machine-to-machine (M2) and Industrial Internet of Things data collection, analysis and visualization.

### BACKGROUND

The monitoring of equipment, facilities and infrastructure is an inefficient, complex and costly process to measure energy, water and operational efficiency. The most common cause of equipment breakdowns are mechanical failures and improper work use by workers and environmental conditions such as heat and humidity levels. However, most systems fail to track or detect these problems and conditions leading to failure or waste of valuable resources. Moreover, current measurement and control systems only measure 40%-70% of building energy consumption using a very limited number of fixed location sensors and do not capture the health of equipment causing problems or used in the delivery of a service. Some industries provide separate supervisory control and data acquisition systems (SCADA) for the machinery involved in manufacturing or process control, but those systems are designed to monitor the flow of a process and do not capture diagnostic data useful for predictive analysis of failures and causes of excess energy or water consumption. Many smaller facilities lack any data collection, control or analysis system with sensors able to generate data for analysis of energy and water consumption or the health of the equipment due to cost and skills constraints. Investment in smart building, analytics and industrial technology is also capital intensive. A major barrier to implementation is a lack of skills and upfront capital costs. In addition, a large information and skill-set gap limits the capacity of businesses to invest in the installation and ongoing management of these static complex systems.

Municipalities and utility companies face difficult challenges in evaluating, maintaining and scaling up an aging facility and equipment infrastructure particularly in urban developed areas with increasing uses of industrial machinery with higher levels of energy intensity in smaller and larger facilities including, for example, refrigeration, 3D printing, communications and data center utility cabinets in remote locations, agriculture grain humidity control in silos and transportation containers, traceability of resources in the food distribution and foodservice chain, food production/foodservice and safety, remote water and oil pumping stations, chiller and water processing in multiple buildings and industries. Less skilled operators have limited tools and visibility to efficiency and operational data at locations or near equipment for analysis and the tools used to collect data and perform analysis require greater levels of skills and technical and management experience. Furthermore, data must be transported to a central data center for costly classification and analysis.

Moreover, in a conventional building or industrial automation scenario using the normal software function execution model, a standard library layout implements centralized rules, limits and instructions by transmitting objects that define limits over a network, by storing those objects in a centralized server database and application session and using it based on need. Detailed raw data must be transmitted from the location where the sensors are located (e.g., machines and facilities) to a centralized server in another location of the facility or in a remote cloud data center. The performance of this entire process is adversely affected by poor network speeds and availability, server capacity and performance.

FIG. 2B is a conceptual diagram illustrating a prior art function execution system that suffers from a number of complex dependencies and deficiencies because of the inter-dependent nature of the cloud-based function model. A client command such as addUser( )is processed through a set of local and remote server nodes over the network including an Own Library node 206, Direct Dependency (ext API) node 210, View with/without direct functions node 214 and Dependency (Driver) node 218. These remote function calls can be interrupted due to network or server conditions, thereby causing failure to the entire process resulting in data loss or lack of reporting views.

The non-uniform code structure that is needed to implement various functions (high level and low level) makes the code hard to understand and debug in complex, multi-tiered computing environments. As seen in FIG. 2B, the lack of a self-contained instruction set makes object interdependency difficult to follow and hard to upgrade and/or deactivate in case of need or hazards. Furthermore, the flow of data through these remote API called nodes can introduce contamination in the form of viruses or other forms of malware and other hazards. An API change can also affect the flow of data resulting in losses of security exposures. They can also introduce data quality issues such as time sequence errors or other data validation errors. Each node must map and implement quality and control measures (best practice) or be susceptible to introduction of bad data affecting critical operational decisions.

### OVERVIEW

Implementations of the present invention provide a mobile computer-based machine-to-machine (M2M) platform for efficient data collection, monitoring, aggregation and analysis of facilities, resources and commercial equipment condition data. By leveraging a plurality of internal and external sensor data streams to a mobile device such as smartphones, wearables and medical devices, blended with external wireless sensors, provides for case-based inspections and investigations, condition-based machine monitoring for: predictive maintenance; visual and acoustic inspection tools; collaborative sharing with remote experts; alerts/instructions; and, real-time data analytics for an operator and/or management at their location with instant replay for correlating data and detecting anomaly using advanced pattern matching and unique code development and execution environment of the present invention.

The inventive case-based and sequence-based approach pre-aggregates and maintains data quality from multiple sensors in real-time rather than by post-processing sensor streams on a server and attempting to synchronize records. Many records using the conventional server processing approach require additional processing steps to cleanse, filter out out-of-synch records and other such data quality processing steps. The case-based and sequence-based approaches may be applied as the industry standard formats for gathering evidence for insurance, compliance, benchmarking and law enforcement, among many industries. The case may also be applied as the standard for machine and facilities service call investigation and resolution. Importantly, implementations of the invention maintain a chain of custody (traceability) for machine and other data from collection to analysis using the case-based forensic process.

Other industries where the invention may be applied include building operation, predictive maintenance services, grid security, aviation, microgrids, utilities, solar power, data centers, agriculture/food safety processing and preparation, cold storage, manufacturing, municipalities and public works, transportation, chemicals and pharmaceuticals, power generation, multi-family, oil and gas, energy, multi-family housing, single-family housing and health care.

Current centralized software and hardware architectures for monitoring sensor data streams and processing data into useful analytical insights requires multiple tiers of processors, data collectors, databases and application functions strung together in an end-to-end process spanning multiple physical and software nodes containing complex application, security and data functions. The lack of end-end functional support at the data collection points introduces many data errors requiring post-processing data cleansing, reduction, classification and reformatting. These steps are eliminated with the present invention including security validation, encryption, authentication and other functions currently resident on many nodes.

The present invention collapses multiple tiers of architecture and nodes into a single node architecture where data is simultaneously aggregated by case, then processed and analyzed using pattern detection and other algorithms, and presented in data visualization to one or more users viewing a dashboard screen. This novel one tier, periodic or continuous one-update process model provides end-to-end compression of cycle times and reduces remote node dependencies while also reducing errors, security problems and quality/hazards introduced into a typical process due to the above-described problems related to remote function calls, copies of data and inter-dependent processing nodes. This process also detects and corrects common data errors including missing values and time-series fields out of synchronization due to incorrect clock issues in multiple nodes.

### BRIEF DESCRIPTION OF THE DRAWINGS

In order to understand the invention and see how it may be carried out in practice, implementations will now be described, by way of non-limiting example only, with reference to the accompanying drawings, in which:

FIG. 1A is a diagram of prior art of data extraction, classification and analysis preparing data for a remote function call to a server where the process is continued until final analysis and visualization steps.

FIG. 1B is a conceptual diagram illustrating a prior art function execution system requiring multiple data acquisition and processing nodes and remote function calls. Function code is compiled into a static plan for execution on multiple nodes. Multiple nodes are required for specific functions from input to extraction of valuable information for transmission to downstream applications for further processing.

FIG. 2A is a conceptual diagram of a prior art process for post-processing detail records into an aggregation forms after loading into multiple data warehouse formats for use by external analysis applications.

FIG. 2B represents a typical remote function call, multi-tier networked architecture with many network and processing node dependencies in a critical end to end process. For example, a typical process 206 may require a critical process step 210 to execute on the same or another node. That process step 210 may be on a remote server requiring a high speed network connection to exchange the data between the nodes. The exchange of data can be corrupted due to programming errors or injected with malware to tamper with the data or process.

FIG. 2C is a functional model of prior art illustrating the complicated node layers for conventional Internet of Things spanning physical devices and networks. There is a multitude of disparate software involved in the data creation to visualization process spanning multiple physical nodes in a network.

FIGS. 3A-3B are block diagrams of a prior art platform n-tier processing node architecture (FIG. 3A) and an inventive one-tier, one-node one update platform architecture implementation (FIG. 3B) for the same complex process leading to analytics and data visualization. FIG. 3A shows the communication between function calls to shared libraries, objects, tools, etc. FIG. 3B shows the end-end content flow logic from data collection functions to analysis and visualization.

FIG. 4 is a flowchart of a mobile analytic engine according to one implementation of the invention illustrating the completion of a complete processing cycle on one node rather than multiple function nodes.

FIG. 5 is a block diagram of the one-tier Playset, Playbook, Playlist architecture according to one implementation of the invention compared to a traditional n-tier data center centric architecture.

FIG. 6A is a diagram of a one-tier, one-node, one-update Playset/Playbook/Playlist architecture according to one implementation of the invention.

FIG. 6B is a conceptual diagram illustrating an exemplary function execution system consistent with certain aspects related to innovations herein.

FIG. 7A references the Playset/Playbook/Playlist definitions described in the appendix and figure. The figure describes the building blocks of the code segments created by our system for execution on nodes. The Playset is used to define the system features used by all of the Playbooks. Playbooks are used by developers to create content flow programs able to handle mixed data and media content flows resulting in a view or analytic export format for third-party systems.

FIG. 7B is a network diagram of the Playset/Playbook/Playlist architecture according to one implementation of the invention where the one-tier, one-node, one-update cycles are distributed so that one node completes the cycle and another remote node can replay the entire cycle using intermediary storage as the mechanism for sharing the context of the process. Alternatively, remote nodes can also share the data visualization screen on the node that creates the content using screen sharing.

FIGS. 8A-8B are diagrams of another example of the one-tier, one-node, one-update cycle context and classification model according to various implementations of the invention including data visualization.

FIG. 9 is a flowchart diagram of an embedded security model according to one implementation of the invention.

FIGS. 10A-10D are screenshots of a real time analysis and reporting model according to various implementation of the invention demonstrating data sequence cycles.

FIGS. 11A-11E are diagrams of mobile analytic engines according to various implementation of the invention.

FIG. 12 is a diagram of examples of non-limiting market segments according to various implementation of the invention.

### DETAILED DESCRIPTION

Reference will now be made in detail to embodiments, examples of which are illustrated in the accompanying drawings. In the following detailed descriptions, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the inventions to these particular embodiments. In other instances, well-known data structures, timing protocols, software operations, procedures, and components have not been described in detail so as not to unnecessarily obscure aspects of the embodiments of the invention.

To solve one or more of the drawbacks mentioned above and/or other issues, implementations herein may relate to a cross-language set of logical instructions used to orchestrate data flow, processing, analytic pattern matching and visualization in one-tier, one-node, one-update cycle. The results can be shared with a best neighbor peer node in the same local network or remote viewing node over the Internet in a separate location. The single node architecture provides scalable processing for workloads sizable by configuration of nodes of different types—USB computer, tablet computer, smartphone, wearable or embedded on a smart TV or other device able to run a playset, playbook and playlists with varying levels of security credentials.

One implementation provides a global one-tier, one-node, one-update time-series sequence cycle behavior schema (hereinafter also referred to as playset/playbook/playlist) that defines programming logic with centralized developed dynamic properties but scoped for local execution, provides a visual/non-visual inventory of data and media elements, storage of processing schemas/formulas, and/or dynamic “routes” to take towards other objects or systems to facilitate cross-API, object and/or library communication on the same node. The routes are shared among playbooks and playlists.

Execution of object functions is performed by commands. Relationships are global any-to-any and infinitely recursive within the one-node architecture. The top-to-bottom priority makes possible overwriting logical sets, if allowed, and keeps the number of playbook parameters to reasonable levels of complexity. The reduction of complexity with this model allows segmentation of development tasks so more developers can personalize the playbook logic to many varying situations, and may be scoped down to a single processing node and/or down to a case within a node. A case can be scoped dynamically to particular unique environment such as a specific location, machinery, zone and other identifying unique secure authentication characteristics.

The playset/playbook/playlist development and dynamic execution model provides a proper secure programmable route for objects to follow when receiving or requesting data for processing, analysis, security, display or streamlining or streaming objects between nodes. A fixed structure is built upon the general needs of external/internal objects and libraries to access each other consistently with full security credentials and protection. A plurality of levels may be used, and may include a more than ten outline-like level structure to use to build a 3D programming environment. The ability to add, edit, and/or delete instructions, even those that are not yet defined may be safely done. Once objects that use them exist, they will be activated. These over-air update capabilities will allow the system to respond to new conditions quickly. It will also allow the system to implement complex processing logic unique to a complex set of unique variables, conditions or situations. The system can detect complex patterns of behaviors and resource consumption based on the unique characteristics of each node and the resources, machines and environments the system is monitoring and analyzing. These capabilities can be used to monitor and detect changes in machine behavior, environments (temperature and humidity), fraudulent activity, cybersecurity threats, all of the above or some combination. A change in network characteristics may trigger alerts or provide data visualization patterns for humans to interpret and act on. Pattern recognition and multi-variate analytics may also detect if an unauthorized condition is detected such as a wireless intruder or unauthorized wireless access point attempting to impersonate a real access point. All of this logic is implemented without the need for coding rules which typical represent known conditions not unknown conditions. Pattern detect algorithms using the unique combination of characteristics for data objects which can represent a parallel sequence of multiple sensor data points organized by location, unique ids and other characteristics. The parallel time-series aggregated data object flows can not only be monitored but exportable for analytic analysis by third-party tools including Microsoft Excel Pivot Tables.

### Overview of Some Aspects

Domain-specific instances will be described with respect to case-based playset/playbook/playlist methods that may be applied in many domains requiring scientific, industrial or cybersecurity investigation, analysis, diagnosis and/or continuous improvement/treatment plans. A decision making Playset of one or more playbook streams using Playlists and a reaction mechanism by using PlayBooks may be implemented for many domains to determine baseline normal conditions and detect anomalies quickly using advanced pattern matching algorithms implemented using a binary data structure that can tile the data across multiple GPUs (Graphic Processing Unit ALUs) and perform matching operations using the parallel processing architecture of the graphics system for data mining using WebGL and other graphic languages designed to display data not process and display data in one-tier, one-node, one-update time-series sequence cycles.

A dynamic playset/playbook/playlist configuration allows a device to make assumptions about the situation and adjust the future decision based on detected deviations from normal cases (case-based pattern matching approach). Over time, the case-based data is collected and aggregated into a searchable centralized repository for faster training of the system for embedding more intelligence into the one-tier playbook model. The case-based approach allows an operator to capture and catalog a base case (normal scenario) that may be used to perform supervised training of the system for continuous monitoring or walkthrough inspection and analysis for anomaly detection. The case-based approach using sequence datasets also allows for continuous monitoring using the one-node device to monitor and analyze multiple on-board and external sensor streams in parallel using one-tier, one-node, one-update sequence update analysis cycles. Comparative analysis or other advanced machine-based learning algorithms can be applied using the timeseries sequence datasets.

All decisions are recorded in Playlists for execution of rules on a single node at a time. The Playlists can be shared within a group of nodes. This approach allows the system to capture human-guided data collection with tagging and annotation (supervised learning) while sharing the results with experts or others who can help optimize the process. The sequences can be played in the same environment, or by changing it, which offers great flexibility and totally different scenarios that could not be done by video/direct recording of data.

The playbook and playset are a multi-dimensional, any-to-any schema designed to collect and organize information into case-based timeseries sequence-based collections of intelligence similar to the process used for forensic science investigations. Case-based collections and playbooks eliminate the need for remote processing otherwise required for correlation analysis processing resulting in total cycle time compression for conversion of raw data into actionable business intelligence and pattern analysis/causal analysis at the point of care/point of investigation. The case structure constrains the processing based on the selection of sensor streams for recording and application of contextual playlist rules applicable to the situation and case. This constraint-based approach using case-based data collection and processing will be used for pattern matching of previous problem cases and solutions for further reduction in cycle times based on a history of similar cases. Cases will be shared with centralized and searchable repositories for machine-based learning to deduce a Playlist ruleset application to certain combinations of constraint parameters. For example, a case-based analysis of a consumer or commercial kitchen for energy consumption may include collection of environmental data such as lighting efficiency, location description by a human for the location of a refrigerator co-located next to an oven generating excessive heat. The co-dependent variables will be discovered and deduced quickly using the case-based approach. Additionally, vibration or other machine data for refrigeration units and cooking appliances (condition based monitoring practices may be employed).

The case file may be pre-aggregated on the mobile node. Pattern matching may be done on the same node using sequence data sets captured by the process. Results may be visualized before sending the pattern detection sequence records to a server for matching with possible related cases and deducing Playlist rules. The server will store and match case based pattern data containers created by the system and generate policy rules for implementation of monitoring applications tailored to the needs of the case-based site. Experts can review case-based sequence patterns and determine cause and effect correlations between different pre-aggregated sensor sequence streams of data.

The system may automatically create case-based learned portable code to address similar scenarios in the future based on timeseries historical sequence and case-based datasets. For example, case-based analysis of different industry energy usage scenarios by zone may provide the pattern matching information used to generate smart playbooks using playlists generated by previous case-based investigations. The key is that using the case-based approach constrains the logic to process on a single node and all other functions are equally constrained to avoid repetitive classification and other non-value add processing on a traditional cloud-based analytic processing system for sensor stream data.

The playbook allows for collection and pre-processing of any type of data from any source including human tagged-input, media and knowledge/feedback (heuristics). The fusion of human-tagged data for location and other relevant case-based data collection contexts may be blended with the appropriate fusion of sensor data streams to form sequential data patterns for normal baseline behavior or detection of anomalies (baseline case). The baseline case is used to establish a normal case for detecting anomalies from the base case. Any change in a particular pattern of behavior for a machine(s) or environment can trigger a visual or remote alert to operators or management. An operator or code in a node detecting an anomalous condition can share the data visualization screen with a remote expert. In other words, the system may support escalation of a capture problem scenario to appropriately notify remote users who may accurately diagnose and determine the severity of a potential problem and take corrective action. The remote viewer can request additional data from the data collection and aggregation node.

Alternatively, a weekly mobile walkthrough inspection can also detect anomalous conditions requiring action. The pattern detection mechanism serves as a predictive maintenance capability not found in most facilities outside of a few advanced industries such as aviation or heavy industrial facilities. The inventive implementations create a unique signature pattern personalized to the specific location and combination of equipment, human and resources. Other systems are incapable of performing this type of dynamic sequential pattern matching recording and matching capability due to the limitations of the n-tier data collection processes and centralized aggregation and analytic systems lacking this level of specificity and context. The user input provides insight into the context of the problem/data combined with possible solutions. User input may also provide opinions using the user sensors normally ignored or not collected and aggregated by machine-based approaches. The aggregation of user input for periodic monitoring scenarios conforms to international process improvement standards including ISO 50001 and the Energy Star energy improvement processes. The expert feedback/opinions can be used to generate playbook rules to distribute to matching case-based situations within a group or similar scenarios within the same company or companies having a unique combination of patterns.

Playbooks may program and read any data source including on-device sensors, connect to local applications or wireless devices using Bluetooth or other wireless or wired protocols. The Playbook node may execute sub-functions accessing APIs on the device to execute local and remote functions specific to the needs of the local scope on the node. Nodes are independent processing nodes not coupled with any other remote service. All node functions are localized and distributed to quickly resolve issues difficult to resolve in a remote function connected processing model (n-tier architecture). Playbooks may be used to program collection and fusion of data from multiple sources including external sensors, on-device sensors, wearable or transportation or other devices with sensors connected via Bluetooth and user tagging into one case-based collection for sharing with cloud-based analytic applications or other devices able to execute a playbook for viewing and analysis. A node may also share its data visualization results screen over the cloud either peer-to-peer within a wireless network or over a private network connection between multiple sites. The Playbook sequence datasets (case-based) may also be stored in local storage for sharing using cloud-based memory or P2P memory sharing systems.

The playbooks are small one-tier, one-node, one-update cycle micro server function applications able to run in memory and storage constrained environments (1M footprint), such as a mobile chip computing device—USB, smartphone, tablet, embedded computer. The small memory footprint allows for easy distribution over any communication method used to distribute standard text-based information or documents. SMS, peer-to-peer or cloud storage systems can transport a sequence of messages and case files from servers or devices to other devices (centralized or P2P) reducing network congestion and processing cycles/costs. The movement of the case and alert files is asynchronous with automatic built-in encryption and compression without code changes to Playsets/Playbooks or Playlists.

Context aware computers may both sense and react to their environment. The case-based sequence dataset approach allows the system to learn faster with smaller datasets and situations. This technique is blended and optimized with machine-based learning to increase the effectiveness of policy-based applications generated by the system for subsequent monitoring of environments and machines.

Playbook nodes operate independently and may share data and playbooks using distributed virtual file systems optimized with additional security and compression for multimedia exchanges or SMS for secure code sharing and distribution. The use of the over the air portable playbooks using encrypted HTML5 and JavaScript reduces the need for device-specific coding and distribution/maintenance. The small footprint codebase may be distributed using novel ways including NFC programmable tags and in some cases encrypted QR codes and other forms of smart programmable local accessible tags. This novel form of code distribution reduces security risks introduced by machines connected to a network exposed to public Internet malicious software and data attacks. The local configuration files and code used to customize the playbook behavior can readily fit into the constraints of smart tags of all types.

In a home and personal environment, Playbook devices can act as a hub for a device mesh or device used to centralize sensor mesh, and main server of analysis and display. Playbooks may program and read any data source including on-device sensors or wireless devices using Bluetooth or other protocols.

Smart home appliance may also act as preprogrammed and adjust according to user actions, sensor readings, and provide alert generation. Sensor array activation order and reading phases accordingly is provided. Child supervision may be provided including gradual adjustment of crib temperature, ceiling star intensity, music, according to child sleep cycle and desired target sleep cycle.

In an industrial implementation, Machine Function Programming (near field-programming using smart tags or wireless protocols without a network) may be implemented to adjust machine data injection (3D model, workflow any-to-any schema etc.) according to a desired outcome, timing, output readings, machine usage level, machine stress levels and other environmental sensors (e.g., to see how data injection is done in industrial machine and how much do the cycles take). Programming is provided on demand using playbooks developed on a local or distributed server for distribution to specific groups of device processing nodes not directly controlled by a centralized, networked computing infrastructure. Programming may also be provided on the node itself using highly configurable settings screens on the processing node device. The behavior of specific sensor streams may be programmed to include cycle timing for sequences and more. The use of a synchronized fusion of sensor streams eliminates the data quality and synchronization errors common in conventional data acquisition systems dependent on cloud-based processing cycles.

Industrial Machine Repair and Simulation screens allow for usage simulation scenarios that may be shared cross-device, usage patterns and outcome stats to adjust native levels, a Fix Sequence that saves, shares, analyzes, creates standard, and adjusts playbooks. The sequences can be replayed individually or multiple sequence stream patterns may be compared side-by-side for anomaly detection or pattern recognition uses and displays. An operator can evaluate discrepancies detected by the real-time analytics processing capability to escalate to other experts.

Virtual Reality implementations include Playset for a three dimensional virtual environment, where a playbook defines possible decisions, tagged equipment and data sensor inputs and a playlist defines decisions made, which is otherwise not possible with video recording alone. A map optimizes and synchronizes user movements inside a given environment. In other environments, replay/timelapse decisions and with other possible decisions mapped by sensing (decisions speed, eye movement, pulse etc.). Case and sequence datasets are organized by timeseries allowing for replay and playback of data/media streams in a playlist viewing session.

In automotive and transportation implementations, diagnostic and repair simulations are based on precedents (playlists). Vehicles. Devices to accomplish these tasks can be mobile devices, robots, drones and other portable or stationary computing environments and devices containing our runtime and frameworks.

In medical implementations, a virtual nurse device may adjust medication quantity according to need/target based on sensor-based input from the patient sensor devices including external sensors, wearables and diagnostic machines. The virtual nurse can share the playlist or case files for analysis and global propositions or consultation with remote or onsite experts for quality assurance or supervision. Demand-driven human intervention may be triggered based on alert trigger rules monitoring and performing pattern and anomaly detection, fail-safe systems for pulse, IV, bed, chair, glass, medications (with the presumption that the most “urgent” patient demands are not urgent and can be foreseen and applied before they need, or safely adjusted by different demands).

A Smart Chair is an implementation where an automated wheelchair for internal/external transport can be programmed with playbooks containing specific rule sets or pattern matching capabilities. Corridor creation and sharing with other chairs according to dynamic playbook is provided in a fast changing environment, without the need for costly equipment, video recording etc.

Botsourcing and task outsourcing is an implementation for automating online/offline tasks normally done by contracted humans using a microservice Playset/Playbook/Playlist codesets running inside an encrypted container service. Examples include accounting where most tasks can be performed automatically based on sensor-data or other data exchange. In a judicial or law enforcement or military setting, active laws are defined in a playset, current case data are defined in a playbook, and actions taken are defined in a playset. Advice may be provided according to extensive data analysis and case data on strategy to implement.

In an energy implementation, the monitoring of industrial and locally installed energy production and distribution equipment is provided. Examples include Smart Grid equipment that learns from energy usage according to environment and internal readings, movement of masses, periodical tendency to consume, vibration signatures, and carbon footprint. Solar Panel or indoor mapping Robots map environment using standardized sensors and adjust according to needs, deploy new panels, adjust direction, etc.

In an agriculture implementation, crop sensors, air and soil sensors, equipment telematics, livestock, biometrics, selective breeding, robots, closed ecological systems, precision agriculture may utilize the invention to detect unhealthy environmental conditions including excess humidity and temperature. Examples include processing lines for optimum times to process raw material according to storage time, time of day, humidity levels that can disrupt machine operation, distance from harvest source, air quality, transport temperature, local temperature etc. The system adjusts and learns in real time using sensors of the data of result.

A problem in the field is the yield is pre-calculated according to very few of these elements. Crop sensor data is used to generate a playbook for irrigation schedule and water composition, trigger alerts, constant analysis and diagnostics to adjust crops to exactly the needed specifications, or learn by doing and program the next crop in a crop rotation cycle.

Equipment environment mapping, corridor definitions and parameter adjustment provide speed of harvest, etc. A Virtual Cowboy or contractor provides constant diagnostics of livestock, adjustment of feed times according to production results, movement stimulation. Self Grow provides a closed ecological system (solarium) that needs constant adjustment and air temp, humidity, lighting, irrigation. A Virtual Redneck provides automation of repetitive tasks. The remote monitoring scenarios can be deployed on drones or other remote controlled vehicles.

A Smart City implementation provides citizen reporting of malfunctioning mechanical or lighting equipment, noises, vibration data such as from transformers tagged with location and machine. A smart lighting system can also provide motion detection for security or traffic light controls.

In a connected car implementation, external monitoring of automotive mechanical systems and automobile parking locations aggregate comfort data. Connected car sensor readings for human comfort levels can also be read by a playbook for use in personalized comfort setting in home or business environments. A car may also be monitored externally for vibration and other serviceability indicators to avoid unplanned downtime.

An occupant monitoring implementation of rented spaces including apartments, offices, data center rack spaces, etc. is provided to monitor water usage on pipes using vibration sensors attached to monitor the water flow conditions for toilets, kitchens and bathrooms.

A connected health/wearables implementation is provided to correlate patient comfort data with environment and automobile, machine operation data where machines can be those used for care such as refrigeration or heating and cooling.

In an aviation implementation, aircraft energy efficiency is affected by cooling/heating distribution. They have same characteristics as any type of building except that their fuel efficiency is affected by the operation of the environmental control systems.

In a mining implementation, mining operations are similar to buildings with industrial equipment. They need air circulation and environmental controls and monitoring/analytics.

In a surveillance implementation, surveillance sensor data may be monitored and filtered, such as through motion detection, video feeds, etc. Pattern matching and other analytics may be performed on one node before alerting a centralized monitoring facility, such as a Network Operations Center. Furthermore, these features may be implemented in critical infrastructure including telecom equipment, microgrids, electric grids, water distribution, parking lots, perimeter lighting systems, border security lighting systems, etc.

A Loosely coupled graph is provided to draw a graph model of nodes, proximity zone relationships including indoor geo-fencing of zones using proximity sensors. This implementation of storage-based and message-based data replication model is differentiated from the REST API-based data exchange model with its security and failure condition problems. REST-base API calls can be easily blocked using a denial of service attack shutting down the network communications between the monitored sensor streams and various inter-dependent nodes. The present invention employs message or storage queues for transportation and synchronization of storage containers but the process itself is self-contained and impervious to network or API disruptions in the network. In fact, it can detect those types of conditions as sequence patterns for fraud and cybersecurity monitoring.

There is also a need to add location-based service and geofencing to establish position outside of wireless range. In another implementation, mapping drones and robots self-guided or remote controlled aerial and ground-based vehicles can map spaces or patrol and gather sensor-based readings by geofenced indoor or outdoor locations. Our case-based approach for organizing case data fits geofencing locations. Aggregating and fusing data is done from on-board and external sensor data streams organized into case files tagged with geofencing data, validation on on-board and installed sensors tied to specific locations.

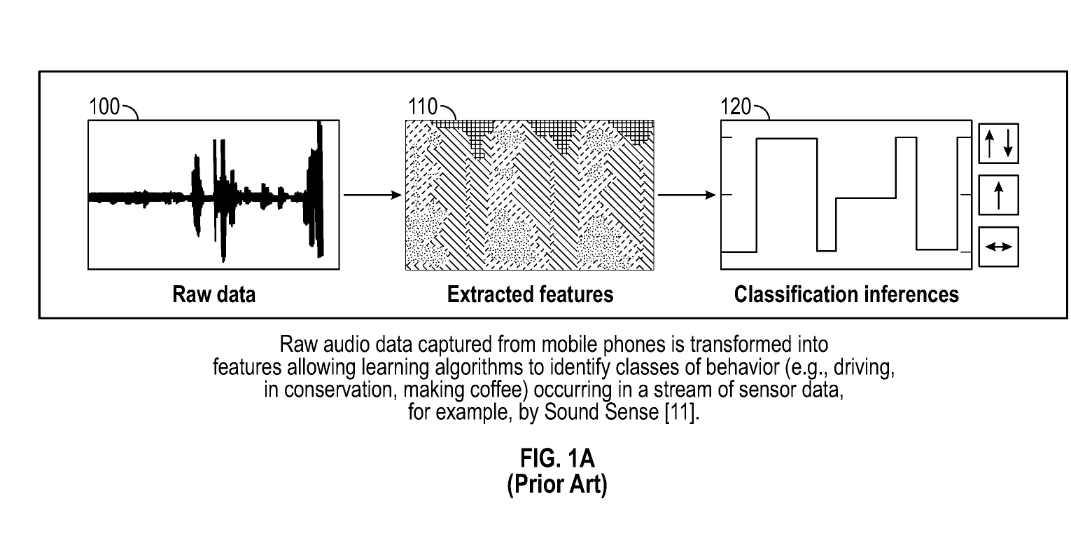

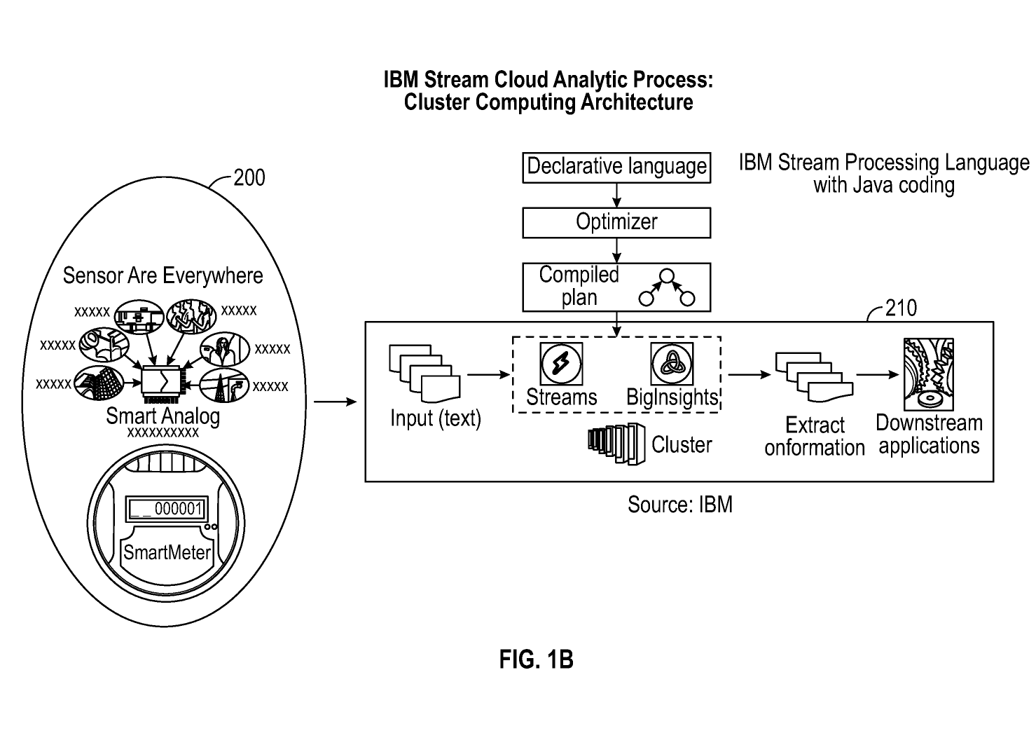

FIG. 1A is a diagram of prior art of data extraction, classification and pattern matching/analytics. Conventionally, raw data 100 is captured from sensors and thereafter features are extracted 110 and then classification inferences 120 are made on remote servers by calling remote functions using REST API calls or XML-based API data exchanges over messaging protocols. This process is time consuming and processor intensive and also susceptible to interruptions in processing cycles due to service interruptions for the network, denial of service attacks, man in the middle attacks and other forms of service disruptions by computers or users attempting to penetrate a network, server or inject harmful data and code into a process.

FIG. 1B is a diagram of a prior art cloud analytic process. In FIG. 1B, sensor data 200 is transmitted to the cloud, such as at a server cluster 210 where extraction and processing of data is performed and then sent to downstream applications over the same or different networks used for the data transmissions. The bi-directional use of the same network infrastructure for sending raw data for processing and transmitting results back can cause undue delays, timing and buffering problems and errors affecting the responsiveness of the process to detect and cause an action to be taken within a short period of time required to take corrective action and avoid undue damage to equipment or affect the safety of an operation causing extended downtimes. For example, a power quality spike can create enough of a disturbance to cause damage and a ripple effect to other connected devices dependent. A process dependent on electrical equipment and network connections can itself fail from the same condition and then miss the opportunity to determine a cause of action. Electrical interruptions affect monitoring equipment in addition to the monitored equipment and environments.

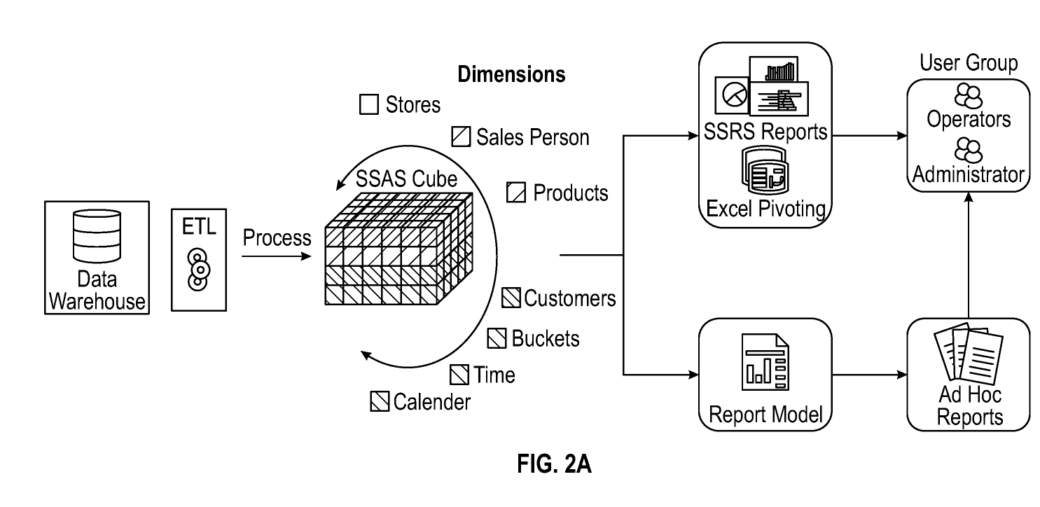

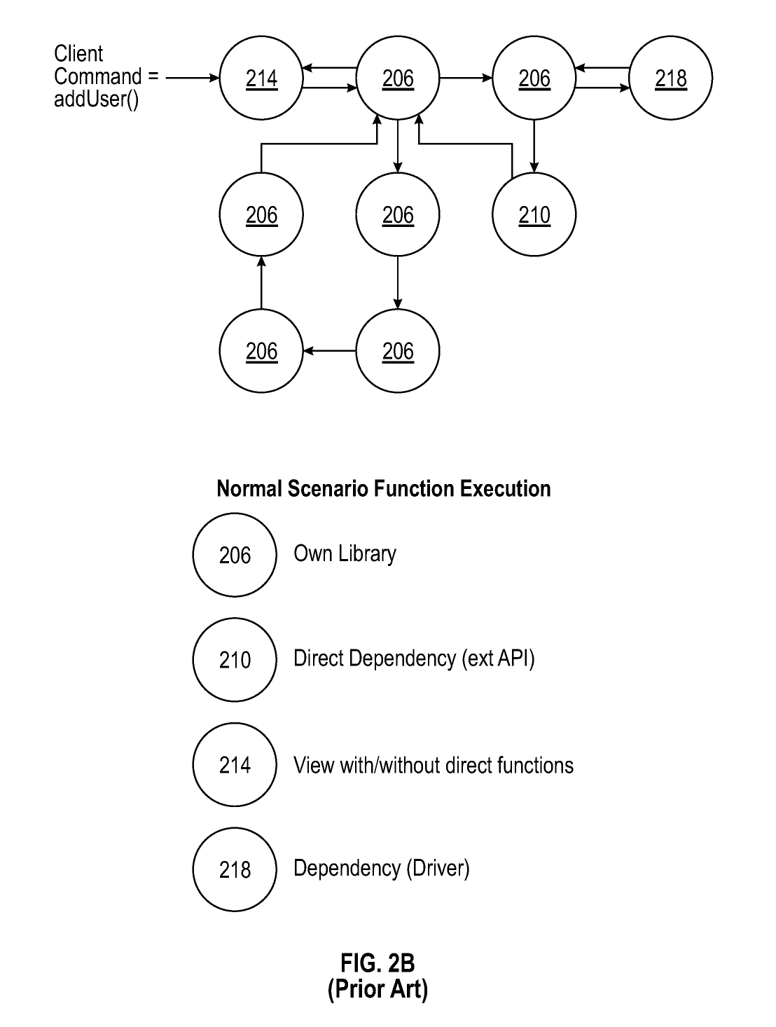

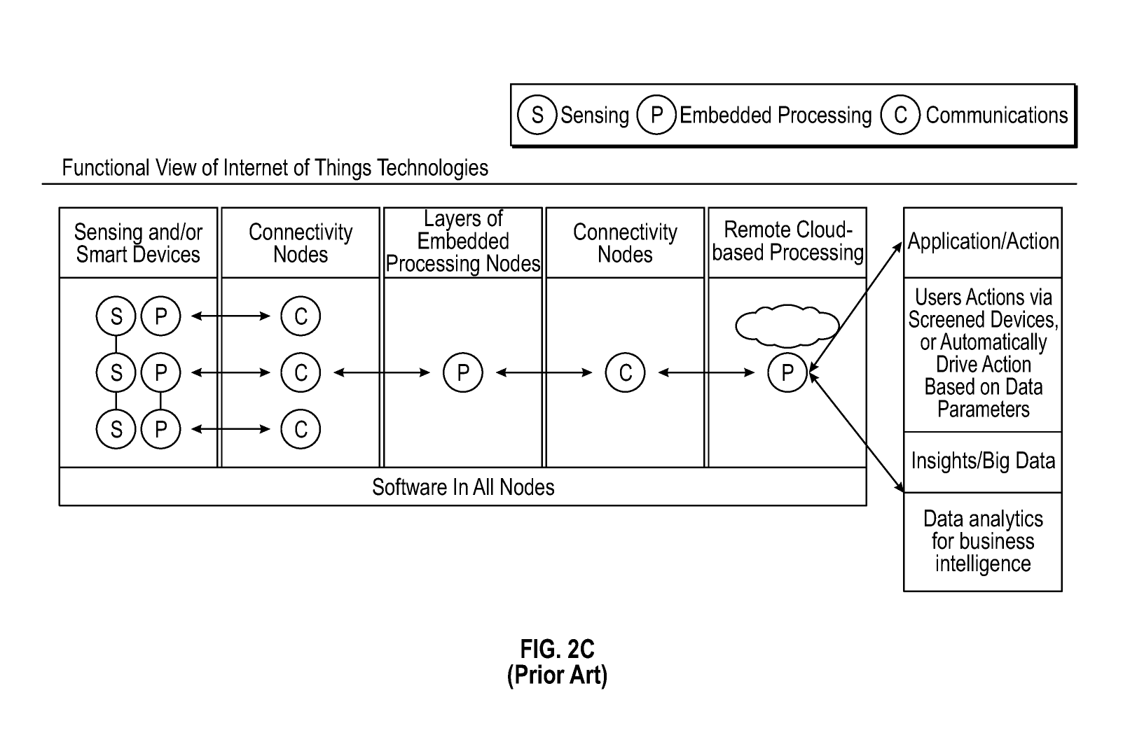

FIG. 2A is a conceptual diagram of a prior art process for post-processing detail records, extracting and transforming the data into aggregation forms after loading into multiple data warehouse formats for use by external analysis applications.

FIG. 2B represents a typical remote function call, multi-tier networked architecture with many network and processing node dependencies in a critical end to end process. For example, a typical process 206 may require a critical process step 210 to execute on the same or another node. That complex process step 210 may be on a remote server requiring a high speed network connection to exchange the data between the nodes. A failure of any of the nodes may cause data losses or security problems. The exchange of data can be corrupted due to programming errors or injected with malware to tamper with the data or process. A multi-node architecture has many attack vectors for hackers to disable the data flow end-end.

FIG. 2C is a functional model of prior art illustrating the complicated node layers for conventional Internet of Things spanning physical devices, software architectures and networks. There is a multitude of disparate software functions involved in the data creation to visualization process spanning multiple physical nodes in a network. The transfer of data between functions introduces potential errors and security breaches if the code does not provide adequate quality security and data checks.

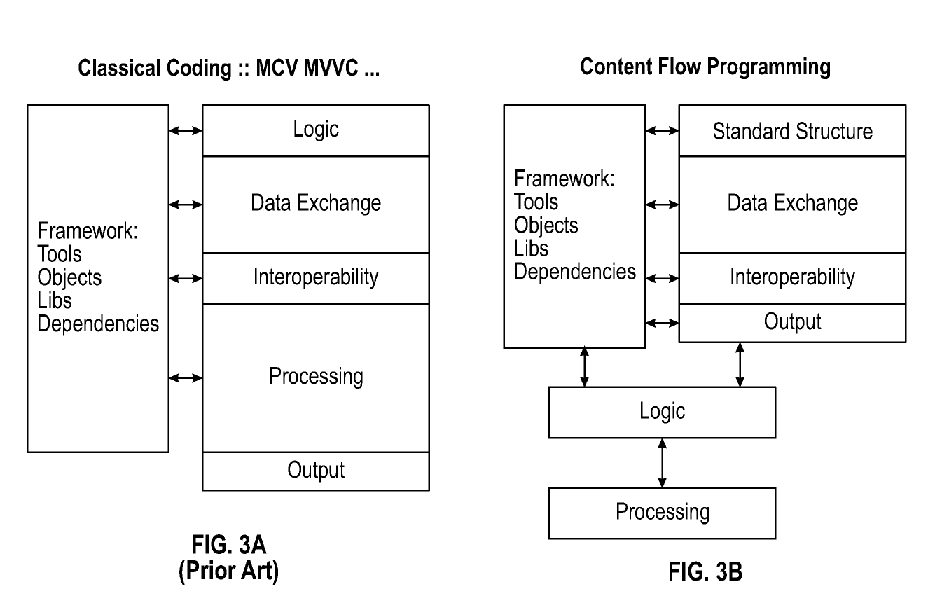

FIGS. 3A-3B are block diagrams of a prior art platform architecture and an inventive platform architecture implementation. FIG. 3A illustrates the classical model-view-controller with many data and code dependencies required to generate output and displays while FIG. 3B illustrates an example of the present invention using the content flow programming platform architecture where function logic is isolated to focus on processing the data objects while the rest of the system is abstracted and managed separately. The separation of logic allows for simplification of data functions in a playset/playbook/playlist so even junior developers can perform advanced data operations without requiring expertise in security, data checking and other functions found in the classic MVC model (FIG. 3A).

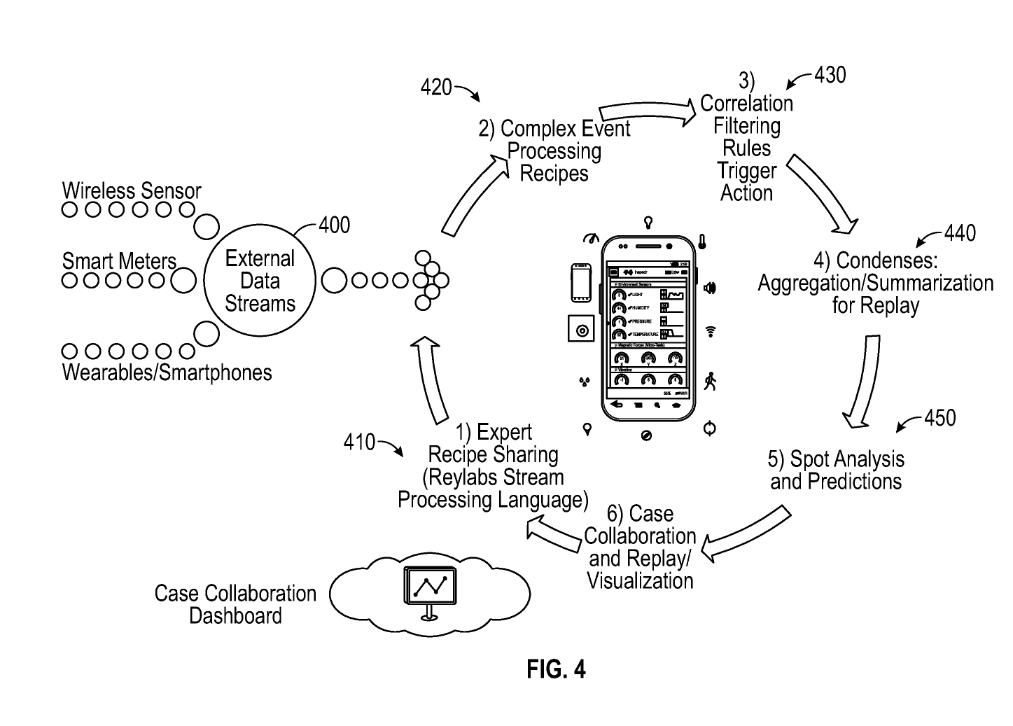

FIG. 4 is a flowchart of a mobile analytic engine example according to one implementation of the invention. External data streams 400 are aggregated in place and include legacy data sources using multiple methods including serial, Ethernet APIs, wireless sensors, smart metering and wearable/smartphone information. The external data streams are organized into parallel timeseries based-case sequence files, processed and synchronized in real-time within the mobile device acting as a one-tier, one-node, one cycle processor without need for cloud processing for any step of the critical process leading to analytics and data visualization of the results. Expert recipes can also be easily codified for sharing 410 is performed prior to receiving the external stream data, and then complex event processing recipes 420 are applied. Then, correlation filtering rules 430 trigger action, and processing is further performed to condense, aggregate and summarize 440 the data for replay. Spot analysis and predictions 450 are then performed and the case collaboration and replay/visualization 460 is provided all without any server or network interaction.

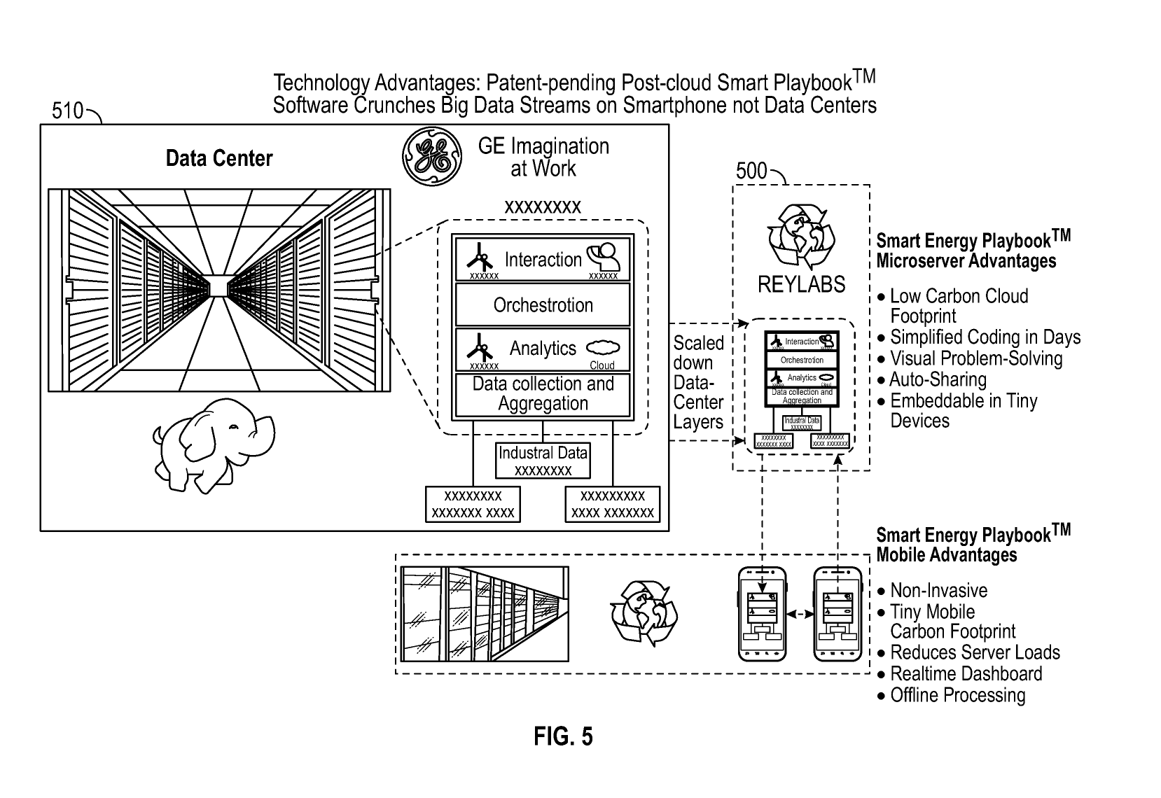

FIG. 5 is a block diagram of a Playbook according to one implementation of the invention. The Playbook architecture allows scaling down of data center layers such to provide processing of a plurality of data streams on a mobile device 500 instead of dedicated cloud data centers 510. Multiple tiers of expensive processing nodes are collapsed into a single node where all data routes are programmed to perform a complex sequence of operations from data collection to analytic processing and data visualization of the results at a rate greater than 20,000 sensor readings per cycle in some node instances. This capability is implemented using a combination of multi-core threads and graphic subsystem parallel GPUs of a mobile device traditionally used for video entertainment purposes. The data is processed in one cycle into binary data tiles loadable in parallel for multi-array pattern matching in memory. This functionality duplicates expensive data center processing using in-memory databases and Big Data platforms used to aggregate, classify and apply pattern matching algorithms. The entire process cycle is performed in one cycle rather than moving raw data to a server that performs classification, then with separate servers for analytics and other data-intensive operations requiring expensive caching memory servers and multiple nodes to accomplish the parallel processing capabilities duplicated by the inventive in-memory case-based scoped approach. The invention provides higher levels of precision and accuracy because the quality of the data from collection is controlled and fused for correlation and pattern matching all in one tier, one node one cycle time.

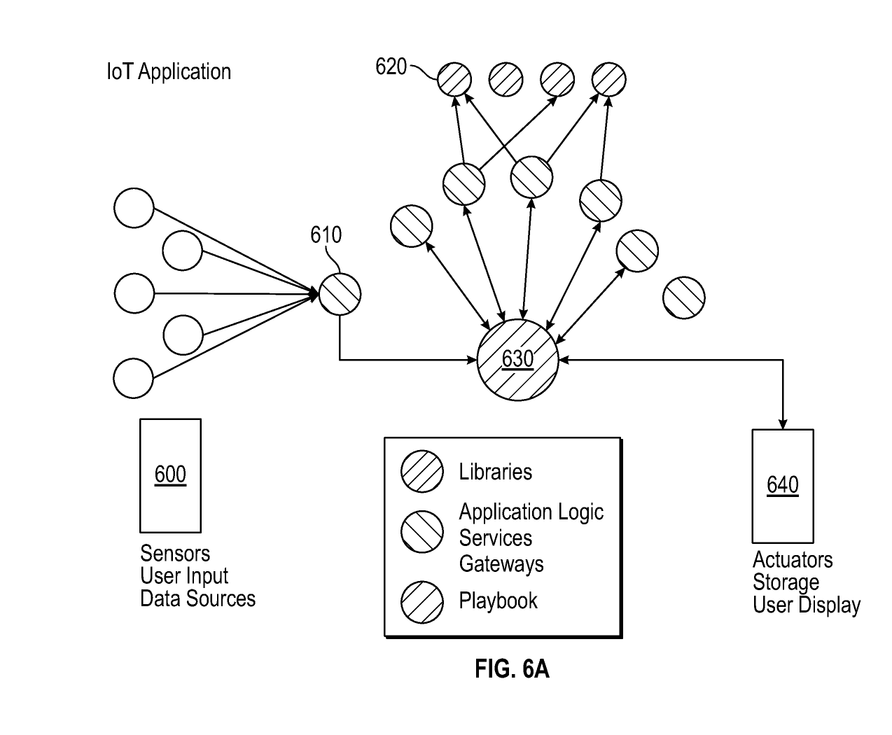

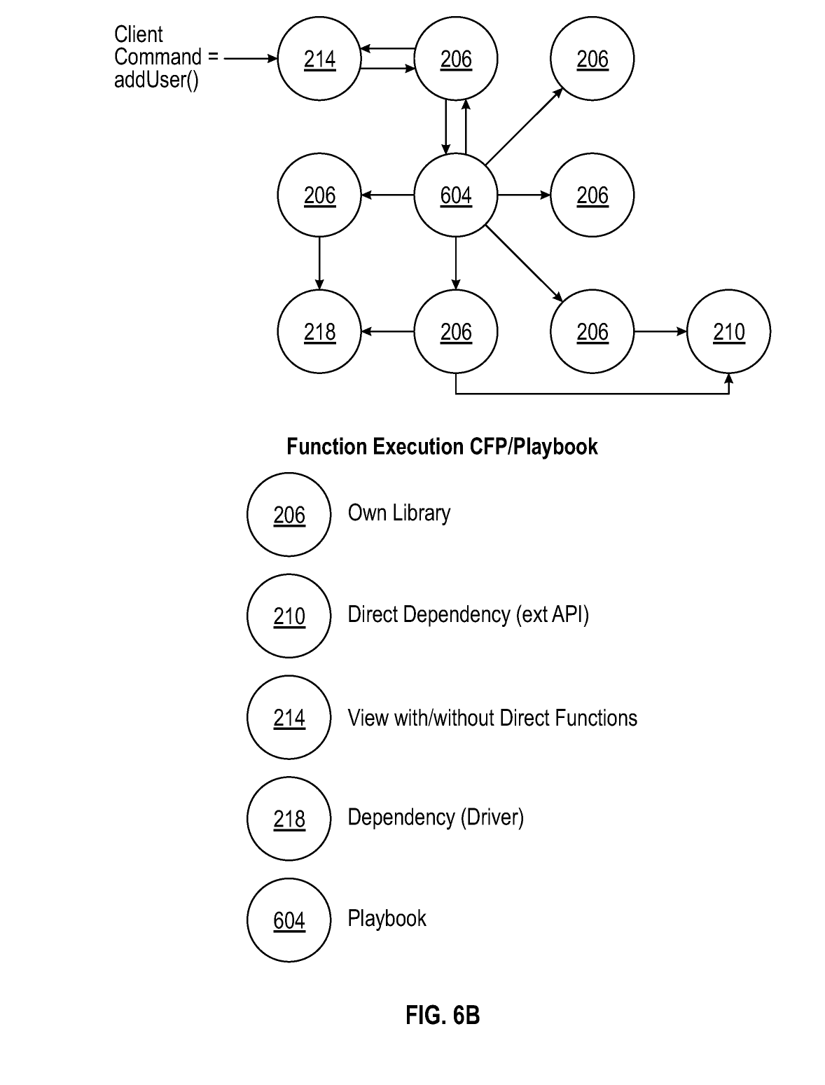

FIG. 6A is a diagram of an Internet of Things (loT) Playbook architecture according to one implementation of the invention. Data 600 is collected from sensors, user input and data sources for application logic 610 such as services and gateways. The logic 610 interacts with the libraries 620 and playbook 630. The playbook 630 in turn provides the output 640 to actuators, storage, user display, etc. The storage may be a separate device shared between different devices and displays.

FIG. 6B is a conceptual diagram illustrating an exemplary function execution system consistent with certain aspects related to innovations herein. A client command, such as addUser( ) is provided to a view with/without direct function node 214. The command may then be processed at an own library node 206 before being passed to the playbook node 604. The playbook node 604 then directs, configures, blocks, limits, modifies or accelerates inter-object data route processing demands and external executions to convert raw data into analytic data streams viewable or exportable to third party applications such as Microsoft Excel. From the playbook node 604, the command may be directed for processing at other own library node(s) 206, direct dependency nodes 210 and dependency nodes 218. The single point of control for the playbook that is constrained by the case-based storage and rules.

In this manner, system complexity and failure/security breach risks are vastly reduced utilizing the case-based approach as an advantage. The more objects and functions, the easier they are to manage. A full global image is available at each step, as well as timed replication of function execution with path and object indicator and replay. The invention may also be implemented in a 3D programming environment with no coding skills needed. The behavior of the playbook can also be programmed by an operator of the device by setting appropriate visual settings such as timing cycles, sequence recording time by case, by fusions of sensors programmed to perform a series of sensor recordings in parallel designed to analyze and generate visual displays or exportable data formats.

Most conventional systems use a config sheet for compiling (grunt/bower), or for configuration. The problem is they all want to control the build process in their own way For example, grunt+bower+angular−Frequire to make them work together you must write much more code in a complex manner.

By contrast, the inventive playbook dynamic assembly, runtime and administration model allows for any type of integration and provides custom tools to facilitate use of third party plugins, APIs, frameworks, in the same or other environments. This approach integrates and simplifies automation tasks for environments and machinery replacing the need for disparate control and monitoring systems. Commands may be programmed to take action directly based on the detection of conditions by the pattern matching algorithms applied by the node as it execute Playbook logic and data routes.

The invention provides numerous advantages. First, the invention defines a clear path for function execution and concentrates application logic into a single dynamic schema, provides insight on methods to use, and makes parallel building or replacing of features easy with no downtime and no risk to application functionality. Parallel programming tasks are transparent to the programmer. The tree-link JSON structure provides a permanent overview of the system logic from $______ core initialization to the simple HTML element. The Playbook executes WebGL and other parallel bitmap processing algorithms to duplicate the parallel processing behavior of Big Data clusters and enterprise OLAP/analytic servers.

Dynamic load balancing and virtual file/object data sharing may be provided transparently by a playlist, so there is no need for load balancers and expensive data center equipment. The invention may also allow and support the use of third party libraries and frameworks that can be easily worked in the application and be controlled just like a native library via Playbook commands that are executing data routes.

Security is also improved in that an object request and/or response may be seen at the deepest level, ensuring easy understanding of where security breaches are possible so that they can be prevented before they happen. The data routes are closely monitored by our intelligent pattern matching algorithms and wireless and wired infrastructure is also monitored for anomalies leading to data quality of data tampering detection. Also, in case of threat detection, disabling part of the system, even at a core level, may be performed very fast with a transparent change to the Playbook code rather than application logic. Developers can focus on data route, sensor programming and pattern matching rather than being concerned about data security like many web programming environments. All objects may also have attached versions, where each different code version provides the same functions (e.g., safe, fast, debug, etc.). The unique data structure with version control described herein is cross-platform and makes the responses containing malformed packages easy to identify and prevent execution. Data flow transformation may be done in a secure container sent to a main system for sharing in a playbook acceptable format using peer-to-peer or cloud-based storage sharing systems. Moreover, all actions that are subject to rules in a front end are checked with the same stored rules in a backend. Any different in result will trigger an alarm.

One implementation of playbook structure is provided recurrent with a limited number of system keywords, defined by the “$” prefix, for example. The programming model is web-based HTML 5 and JavaScript coding, not low-level Java or other complex enterprise object-oriented languages. All nodes may have a predefined structure attached to them to define different sets of data needed for processing. Enhancing the structure is done without a predefinition of names and conventions, which makes core level library development fast and clear.

One implementation of the playbook structure is provided below:

```
$playbook - name
  $type - naming definitions
  $sets - predefined structures that can be attached anywhere
  $rules - rules of execution, dataln/dataOut, access rights
  $elements - element definition to be used globally inside the playbook
  $elementName
    type: { } -- name, parent, part (template part)
    prop : { } -- properties to pass to template engine
    attr : { } -- HTML attributes to be used in visuals
    data : { } -- data source, path to data (JSON structure requires path, unlike
    SQL)
    comm : { } -- v3-data- attributes to be used in UI functions
    rules : { } -- system {allowKids, maxKids, valueList, regex}, in :{data in}, out: {data out}
$data - main data source
$plays - plays by category
  $component - fixed list: form, table, grid
  $componentName
    type: { }
    prop: { }
    attr : { }
    data: { }
    $structure
      $elementGroup -- in the HTML it will be called as
      {{$elementGroup.$elementName}} -- {{forms.addUser}}
    $elementName -- can be from $elements. Any instructions defined here will overwrite
    the defaults
```

FIG. 6B is a conceptual diagram illustrating an exemplary function execution system stream analytics programming language used by the Playbooks consistent with certain aspects related to innovations herein. Next, exemplary code for preparing a playbook is provided below:

```
private function _prepare playbook($playbook) (
  $this->parentPriority = (!empty($playbook[‘rules’][‘global’][‘priority’])) ? true : false;
  if(_array::is($playbook[‘elements’]))
    foreach ($playbook[‘elements’] as $elNarne => $el) {
    $playbook[‘elements′][$el[Narne] = $this->_parse_system_vars($el,$playbook));
    $playbook[‘elements’][$elName][‘rules’] =
$this->_merge_rules($el[‘rules’],$this-
>_parse_system_vars($playbook[‘rules’][‘elements’],$playbook));
          )
  If(_array::is($playbook[‘rules’][‘plays’])) (
    $useRules = $this->_parse systern_var($playbook[‘rules’][‘plays’]);
    foreach ($useRules as $ruleCat => $ruleSet)
    if(_array::is($playbook[‘plays’][$ruleCat]))
    foreach ($playbook[‘plays’][$ruleCat] as $compName => $compArray)
    $playbook[‘plays’][$ruleCat][$compName][‘rules’]=
$this->_merge_rules($playbook[‘plays’][$ruleCat][$compName][‘rules’],$useRules[$ruleCat]);
        )
        If (_array-::is($playbook[‘plays’]))// -- Merge ELEMENTS :: after ruleSet and
        defaultSet
          foreach ($playbook[‘plays’] as $compsNarne => $comps)
            foreach ($comps as $compName => $comp) (
              $playbook[‘plays’][$compsName][$compName] =
$this->_parse_system_vars($comp,$playbook);// -- apply $set to components
              foreach ($comp[‘structure’] as $elGroup => $elArrey)
                foreach ($elArray as $elName => $el)
$playbook[‘plays’][$compsName][$compName][‘structure’][$elGroup][$elName] =
$this->_parse_system_vars($el,$playbook);// -- apply. $set && get
            )
        // erase $generated
        unset($playbook[$generated’]);
        return $playbook;
      )
```

FIG. 6B is a conceptual diagram illustrating an exemplary function execution system consistent with certain aspects related to innovations herein. A set of terms are defined to better explain the playbook structure and naming convention. A level is a level inside the tree structure, from left to right, according to distance in nodes. Elements belong to level 1 of $playbook and defines all visual elements that will be used in the playbook. plays provide the logic behind specific objects and inherit rules from the main $playbook. Components refer to a general node that defines major type of visual components. The structure may be used for WYSIWYG development using visual programming of logic using a network outline structure familiar to most word processing or spreadsheet development workers. Component is a logical structure for building, processing and/or routing visual element. structure is a logical structure that defines element groups and routes data flow inside JSON. elementGroup is a major type of visual component group. Element is a visual component definition. Attribute is a node/element logical definition and may be, for example, type, attr, data, comm, rules. Node is a general name for any array key inside the playbook at any level. $sets is a predefined set of rules that can be attached anywhere. Complex multi-array processing is simplified for pattern matching and other advance comparative correlation analysis needs.

Each playlist is preprocessed and compiled to offer access to an object at maximum loading and processing speed. When part of the full playbook is demanded, it is subjected to a user level check and the response is a full list that does not need any processing. The $generated version is much bigger than the displayed one and contains system and security triggers built into the system. The application developer does not have to be concerned with the underlying security protocols and algorithms used to prevent data tampering for fraud, control tampering or other objectives.

All the objects may have three different uniform structures that are easy to recognize and replicate. Furthermore, the clear path and logical naming schema makes it very easy to understand complex instructions and execution data route chains, without limiting direct call to objects (if that is what is wanted). For onSave, the invention is precompiled into two generated versions. The first version adds tree structures that have an overwrite priority from bottom to top on everything. The second version is a flat version that optimizes a request from 2D objects like HTML, mobile AJAX, etc. Rules are an important aspect of the playbook. Rules may be implemented globally, overwritten at element level or attached with $sets. Rules may be generated and specific to anything ($object—system naming convention).

Inner Playlist Relations are global any-to-any relation and infinitely recursive. User access may be limited on any level for collaboration.

The present invention also provides advantages in terms of size by providing a very low footprint compared to traditional native code languages. For example, a very complex global framework would have an approximately 1MB playlist. This small and efficient footprint makes the platform the lowest carbon footprint processor per MB of data. The small footprint also fits the processing and energy consumption constraints of distributed equipment with network and energy consumption limitations such as solar powered equipment stations.

Hundreds of instructions are currently defined, but thousands more may be generated quickly within a short time frame such as a few months to support a growing variety of conditions and equipment configurations. The invention may be upgradable for a 3D visual model of step by step execution simulation for debugging and fine tuning. The system may also store a command list and a demand to replay an execution cycle completely separate from the node that created the case files containing any—any data mapped into binary formats compatible with loading as data tiles in the GPU subsystem of parallel ALUs. Programming logic is provided with centralized dynamic properties that is a global behavior schema for complex environments. A single data structure is provided for all environments with unlimited lateral and vertical scaling. Inner playlist load balancing is provided with sync over unlimited systems and languages. Scaling is provided via push only and full traffic dispatch.

Automation is accomplished for front-back/back-front data exchange and object construction that is easy and streamlined using indirect synchronization of case-based storage over peer to peer synchronization software or cloud-based storage sharing. Object replacement/deprecation is also provided with zero down time. Ease of use is also a benefit as no coding skills are needed other than basic HTML or spreadsheet programming. Automation is also provided for template composition and any other framework integration (backbone, underscore, jq, angular) transparent to the Playbooks. New data visualization and navigation structures can be implemented transparent to the Playbook code. The Playbook code inherits the revised views without changes to underlying code. The transparent upgrade process allows the system to quickly incorporate new sensor streams, algorithms, views, hardware acceleration features such as additional storage, CPUs, GPUs, ALUs and caching internal and external to the node. New external wireless and attached capabilities can be quickly integrated transparent to the Playbook code.

In another implementation, the playbook is implemented to automate and aggregate data flow on a mobile device where aggregated data is processed on the mobile device into a visualization format for instant playback and viewing. Processing of raw data from a plurality of sources such as a plurality of sensors of the mobile device may be performed into one language on the mobile device. The processed data may be transmitted to another device, such as a server, smart TV/displays, tablets, devices or other compatible computers including personal computers and embedded computers. Smart TVs able to run HTML and JavaScript code can also embed our 1M runtime to process case files on a peer basis. Smart TVs and monitors can also share screens between smartphone-based nodes and displays easily enabling collaboration using WiFi direct to establish a safe connection within range or over WiFi to a remote display discover using the screen mirroring capabilities of smart displays and smartphone/tablet computers. Importantly, the data may be played back, but does not execute code such that transmission/reception of the playback data cannot execute malicious code such as malware.

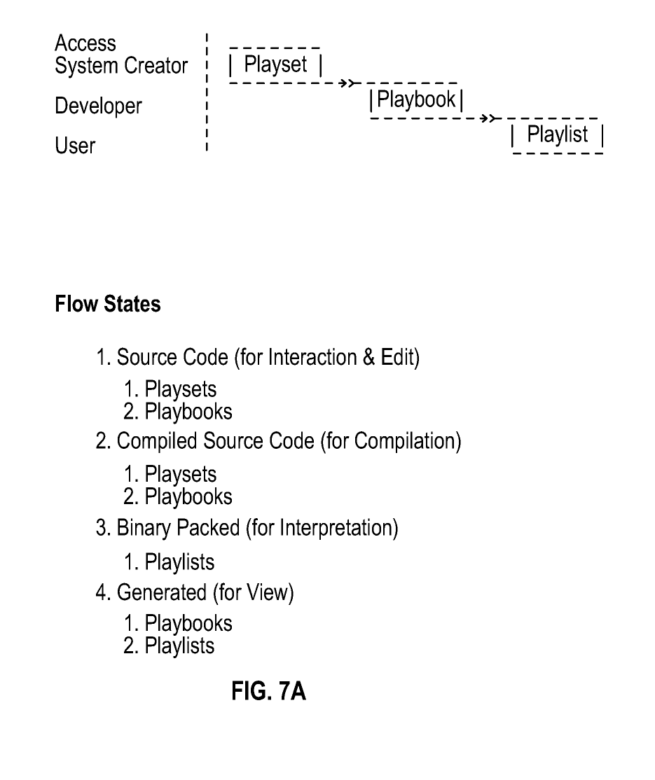

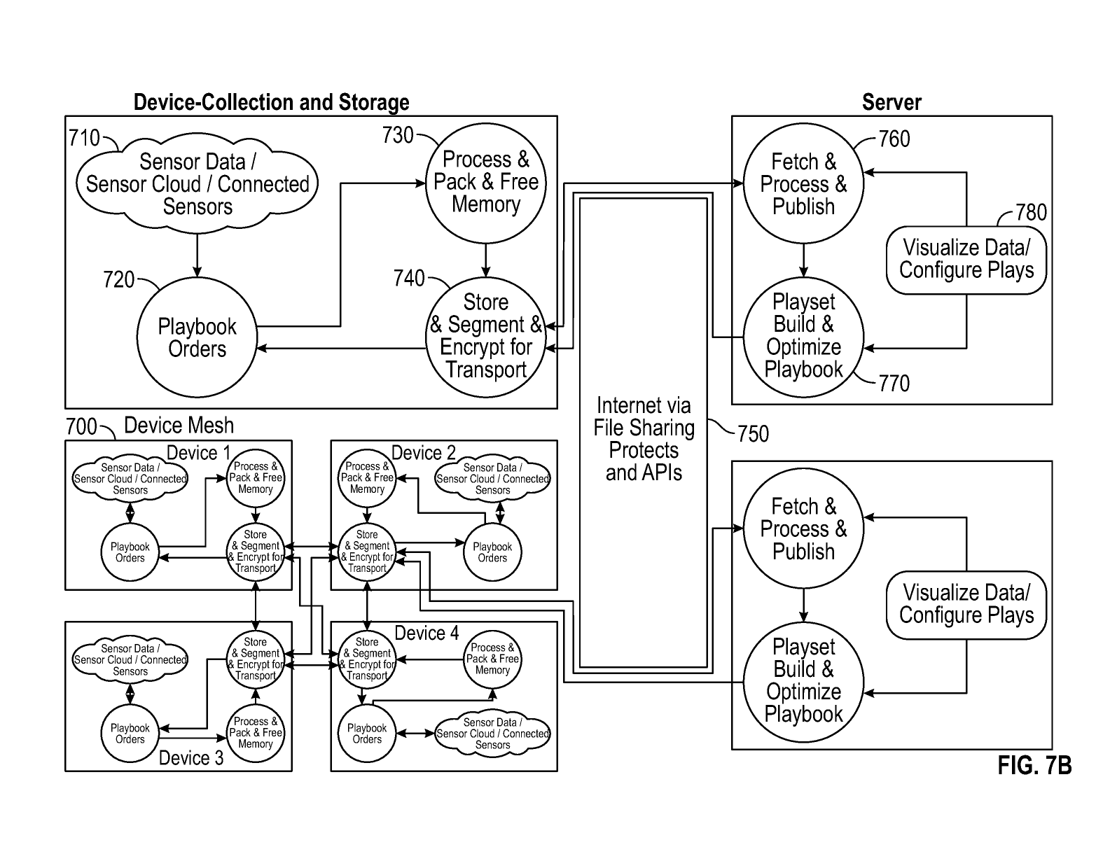

FIG. 7A references the complete description of the Playset/Playbook/Playlist model defined in the appendix and figure. The figure describes the building blocks of the language-independent code segments created by our system for execution on nodes and described earlier in this document. The Playset is used to define the system features used by all of the Playbooks. Playbooks are used by developers to create content flow programs able to handle mixed data and media content flows resulting in a view or analytic export format for third-party systems.

The flow states in the figure and appendix define different formats from source code to binary packed and generated view code configurations. The binary packed formats provides unique key-based security for the code segments to detect and prevent code tampering used to inject malware or change or corrupt data. The entire flow includes user rights, obligations for data and code (see appendix). Further security is provided by split code segments known to the Playsets and Playbooks having the unique security credentials.

FIG. 7B is a network diagram of the Playset/Playbook/Playlist architecture according to one implementation of the invention. A plurality of devices 700 may each receive sensor data/sensor cloud/connected sensor 710 data that is provided to playbook order node 720. The data is then processed, packed and provided 730 to free memory within the constraints of a device for storage, segmentation, encryption and transport 740 to other devices or to a server via the Internet 750 via file sharing and display sharing protocols and APIs. The server may fetch, process and publish 760 the data and/or the PlaySet further builds and optimizes the Playbook 770. The data may be visualized or configure plays 780. The transparency of the Playbook code from the case-based storage allows for portability of analytical results and raw data packaged into efficient binary formats for accelerated loading and processing into data visualization of results on any device with a GPU subsystem. Further optimizations can be made specific to different hardware configuration with various new acceleration features for WebGL, HTML, JavaScript or binary visualization objects.

A write-once in-memory object updating process supports the one-tier, one-node, one-cycle update so that views are simultaneously updated when the object is update in memory. The object is then saved in an optimized binary format for streaming to other devices or shared via file synching mechanisms or display sharing.

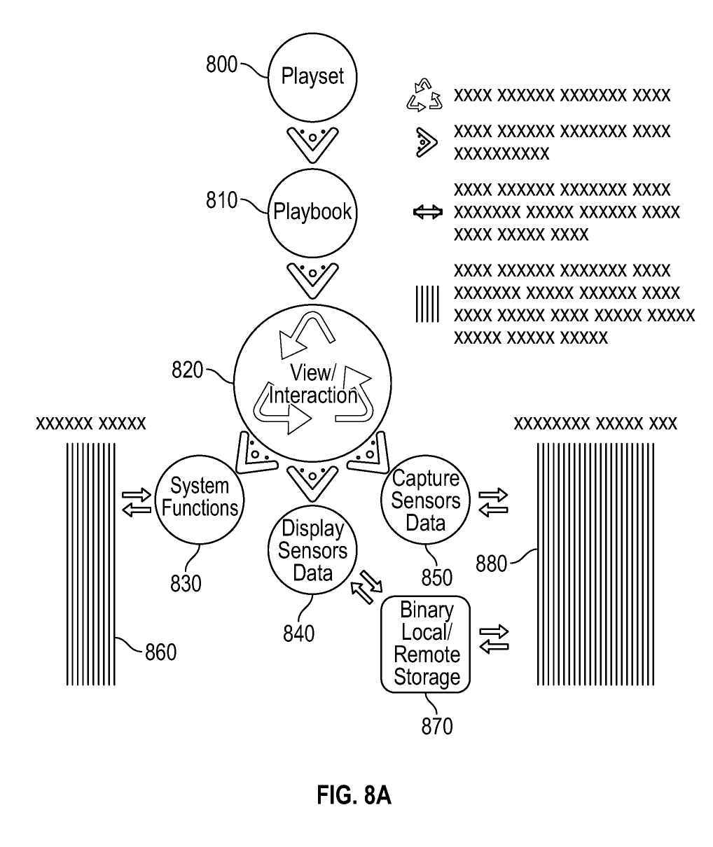

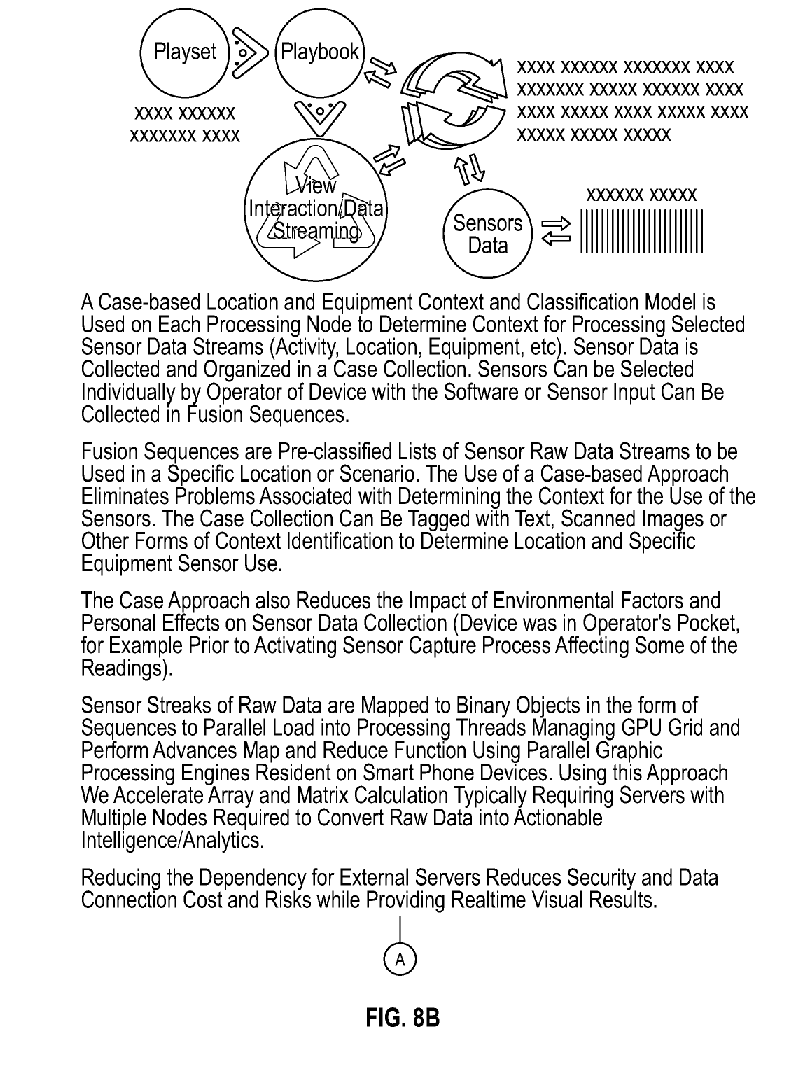

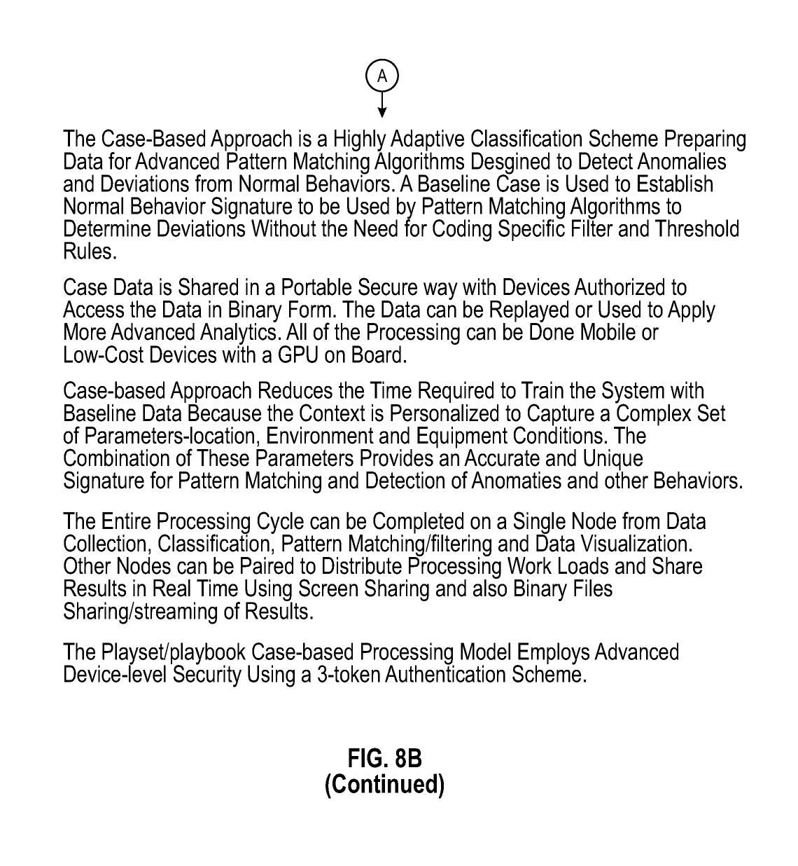

FIGS. 8A-8B are diagrams of a context, classification and analytic model according to various implementations of the invention. Playset 800 instructions are sent to a Playbook 810, that are then sent to a View/Interaction self-updating environment 820 which outputs data to one of system functions 830, display sensors 840 and capture sensors 850, which utilize threads and memory 860, binary local/remote storage 870 and OpenGL threads and memory 880, respectively. The asynchronous write-once behavior of the system compresses multiple repetitive, redundant processing typically performed on multiple cloud server nodes into one pass updates using the one-tier, one-node, one-update cycles.

A case-based location and equipment context and classification model may be used on each processing node to determine context for processing selected sensor data streams (activity, location, equipment, etc.). Sensor data is collected and organized m a case collection. Sensors may be selected individually by a user of the device with the software or sensor input can be collected in fusion sequences.

Fusion sequences are pre-classified lists of sensor raw data streams to be used in a specific location or scenario. The use of a case-based approach eliminates problems associated with determining the context for the use of the sensors. The case collection can be lagged with text, scanned images or other forms of context identification to determine location and specific equipment sensor use.

The case approach also reduces the impact of environmental factors and personal effects on sensor data collection (e.g., device was in operator's pocket, for example prior to activating sensor capture process affecting some of the readings).

Sensor streams of raw data are mapped to binary objects in the form of sequences to parallel load into processing threads managing onboard GPU grid and perform advanced map and reduce functions using parallel graphic processing engines resident on smartphone devices. Using this approach we accelerate array and matrix calculations typically requiring servers with multiple nodes required to convert raw data into actionable intelligence/analytics.

Reducing the dependency for external servers reduces security and data connection costs and risks while providing real-time visual results.

The case-based approach is a highly adaptive classification scheme preparing data for advanced pattern matching algorithms designed to detect anomalies and deviations from normal behaviors. A baseline case is used to establish normal behavior signatures to be used by pattern matching algorithms to determine deviations without the need for coding specific filter and threshold rules.

Case data is shared in a portable secure way with devices authorized to access the data in binary form. The data can be replayed or used to apply more advanced analytics All of the processing can be done on mobile or low-cost devices with a GPU on board.

The case-based approach reduces the time required to train the system with baseline data because the context is personalized to capture a complex set of parameters—location environment and equipment conditions. The combination of these parameters provides an accurate and unique signature for pattern matching and detection of anomalies and other behaviors.

The entire processing cycle can be completed on a single node from data collection, classification, pattern matching and data visualization. Other nodes can be paired to distribute processing workloads and share results in realtime using screen sharing and also binary file sharing/streaming of results.

The playset/playbook case-based processing model employs advanced device-level security using 3 token authentication scheme.

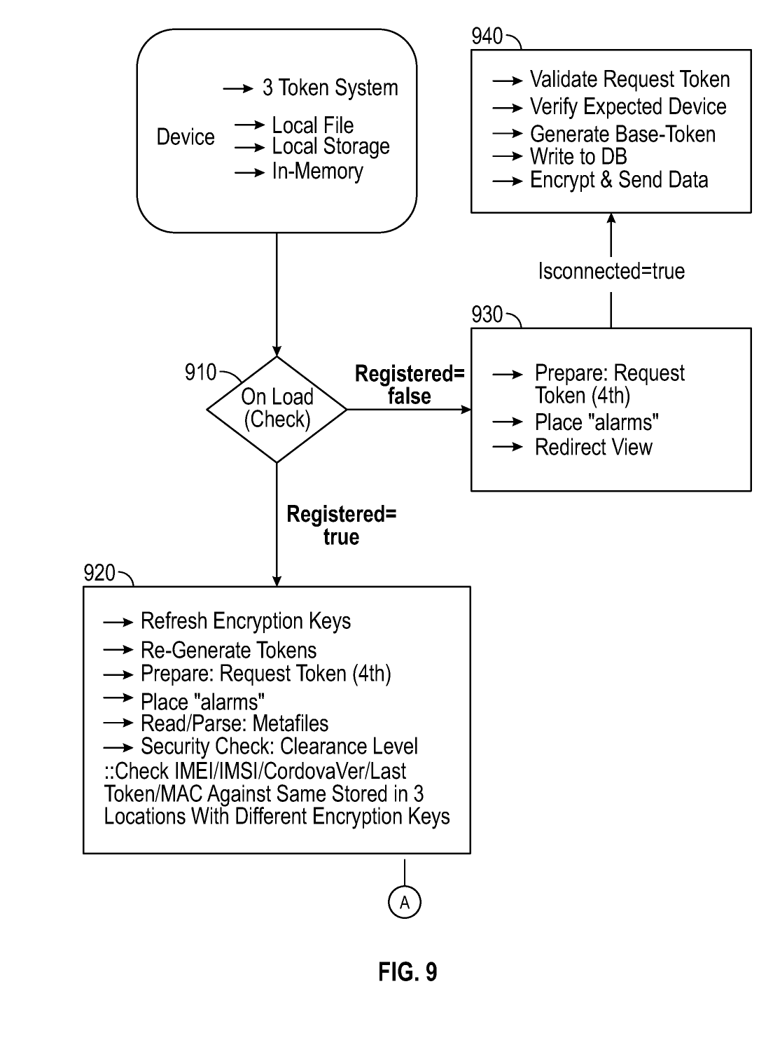

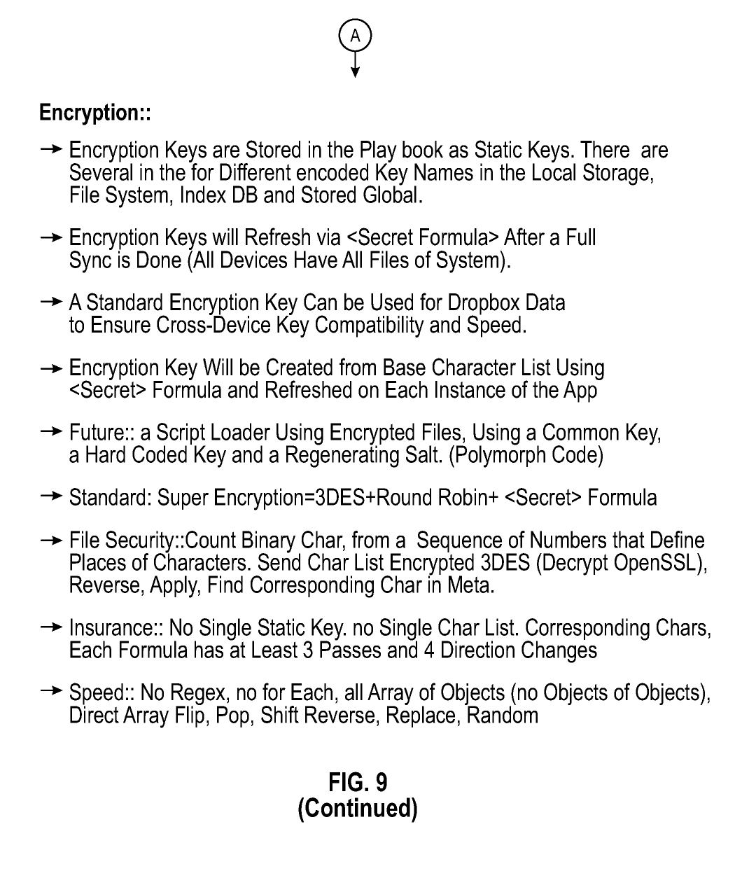

FIG. 9 is a flowchart diagram of a security model according to one implementation of the invention. A device at step 900 includes a three token system for the local file, local storage and in-memory. At step 910, an onLoad check is performed and if registered, proceeds to step 920 where encryption keys are refreshed and tokens are regenerated.

If not registered, step 930 prepares a fourth request token, place alarms and redirects a view. Then, if the device is connected, the request token is validated at step 940, written to a database, encrypted and sent. The multi-token system cannot be accessed or bypassed by traditional code or data injection methods designed for databases. The disclosed methods may detect and prevent any traditional malicious attempt to disrupt operations because of a lack of traditional web tiered architectures and protocols susceptible to harmful disruptive actions.

Encryption keys are stored in the playbook as static keys. There are several keys used for different encoded key names in the localStorage, fileSystem, IndexDB and stored Global.

Encryption keys will refresh via <secret formula> after a full sync is done (all devices have all files of system).

A standard encryption key and other unique identifications can be used for virtual file systems like Dropbox or systems used to provide virtual file services for nodes containing Playset/Playbook/Playlist code for data to ensure cross-device key compatibility and speed.

Encryption keys will be created from base character list using <secret> formula and refreshed on each instance of the app.

Future::a scnpt loader using encrypted files, using a common key, a hard coded key and a regenerating SALT, (polymorph code).

Standard: Super Encryption::3DES+roundRobin+<secret> formula

File Security::count binary char, form a sequence of numbers that define places of characters, send char list encrypted 3DES (decrypt openSSL), reverse, apply, find corresponding char in Meta.

Insurance::no single static key. no single char list, corresponding chars, each formula has at least 3 passes and 4 direction changes.

Speed::no regex. no for Each, all array of objects (NO objects of objects), direct array flip, pop, shift, reverse, replace, random.

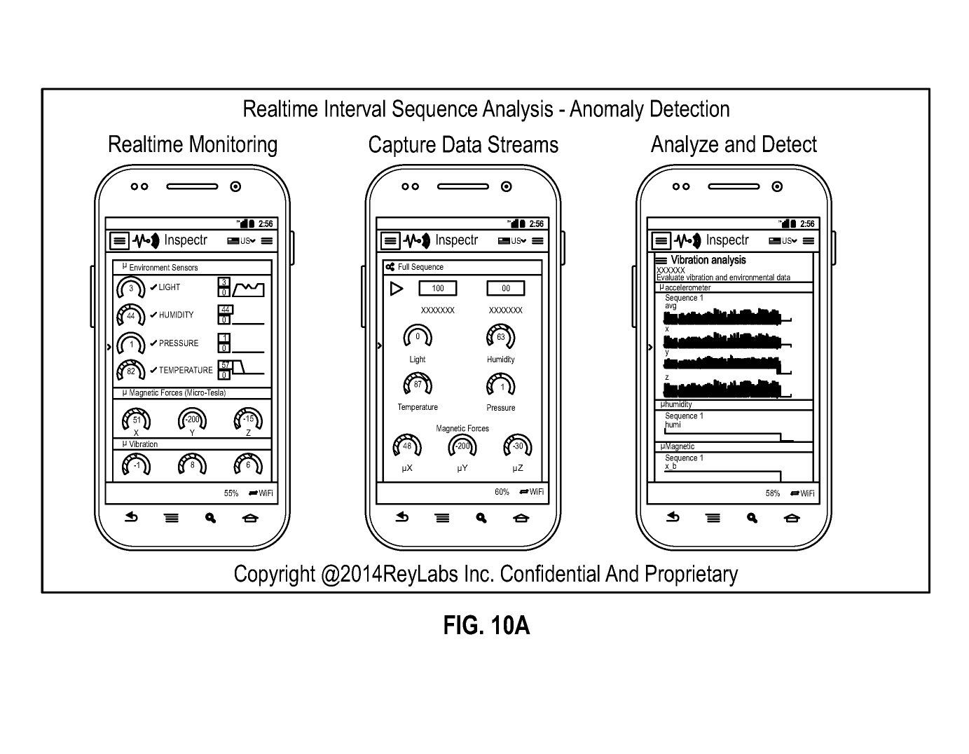

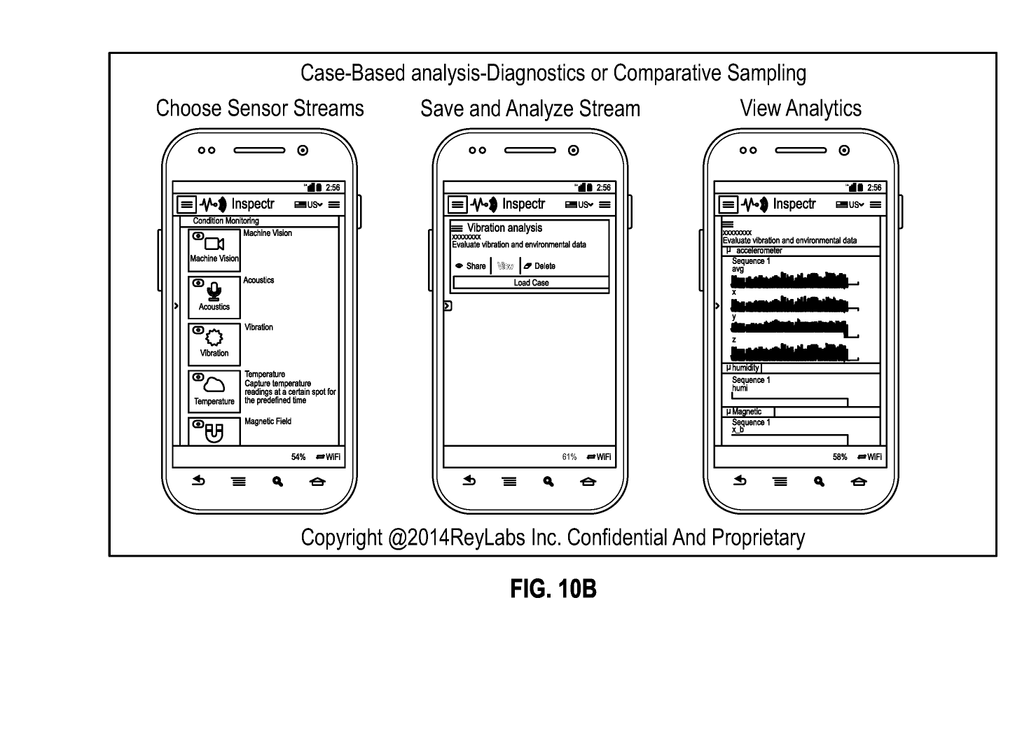

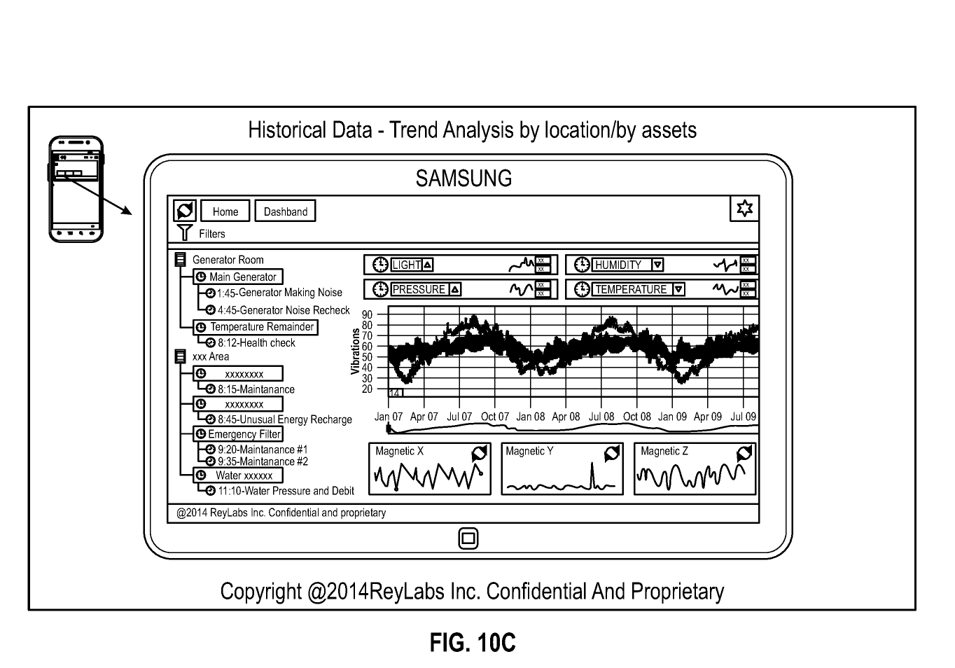

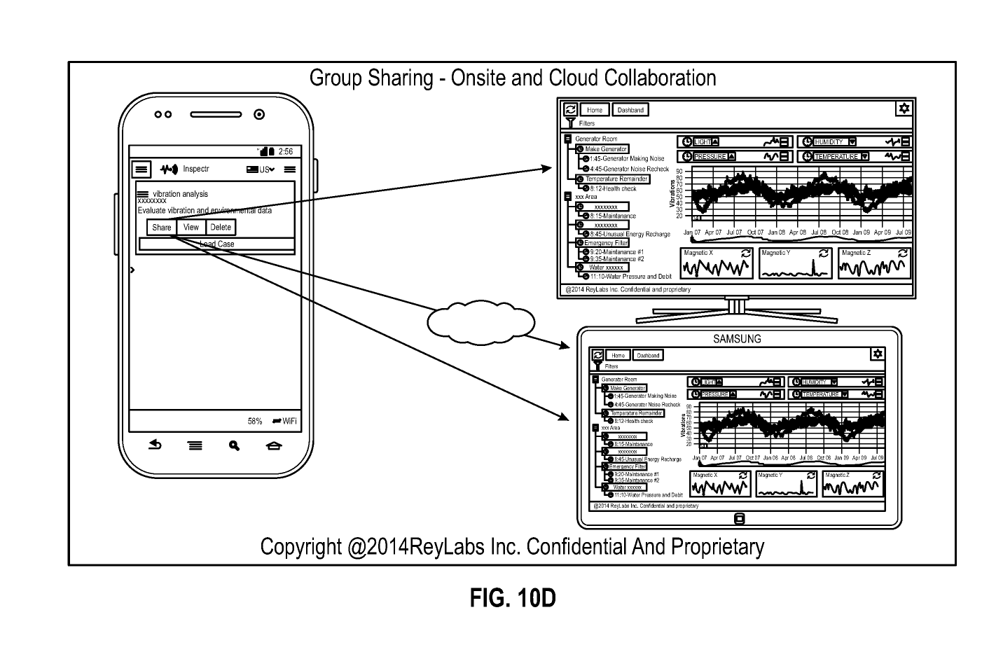

FIGS. 10A-10D are screenshots of a realtime analysis and reporting model according to various implementation of the invention. FIG. 10A illustrates real-time interval sequence analysis for anomaly detection using a walk around monitoring method, but it may also support continuous monitoring mode using an unattended device programmed to continuously monitor sequence data operations and pattern matching. FIG. 10B illustrates case-based analysis including diagnostics or comparative sampling over a limited periodic time period or over a longer period of continuous monitoring. FIG. 10C illustrates historical data trend analysis. FIG. 10D illustrates group sharing via onsite and cloud collaboration either peer to peer or using storage to share case-based data optimized for binary loading of multiple arrays of sensor streams in parallel into the GPU system for pattern matching and data visualization simultaneously.

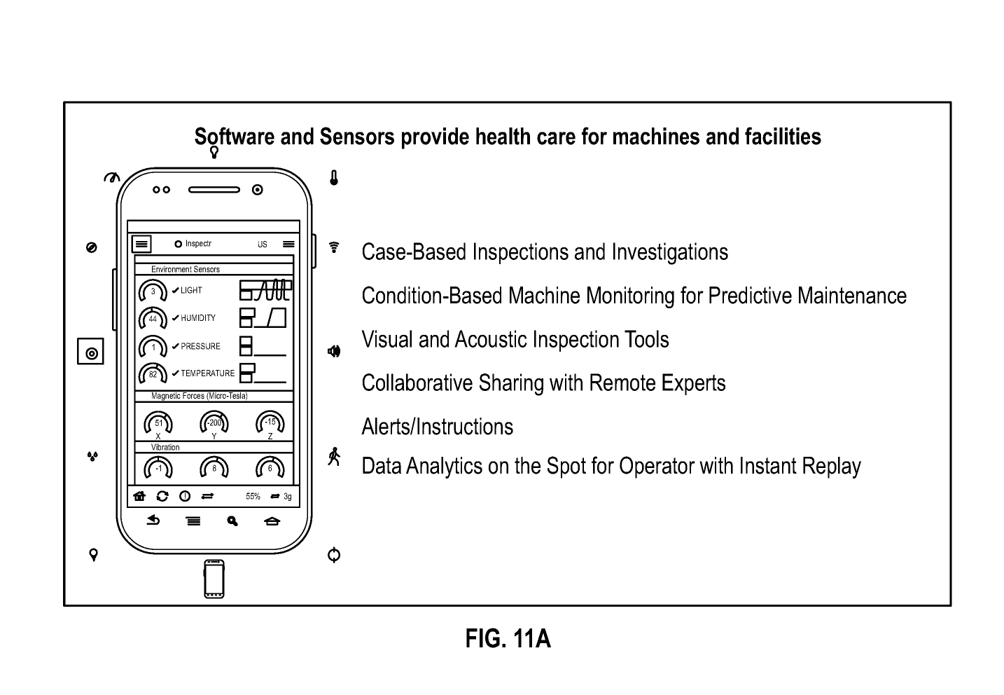

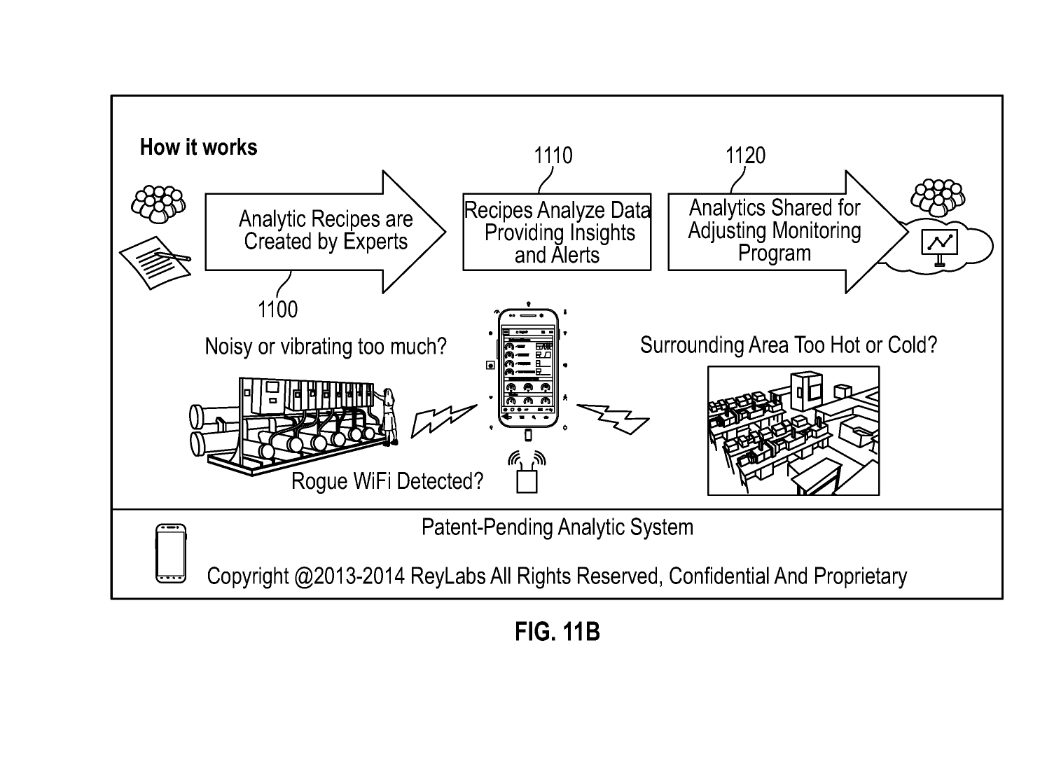

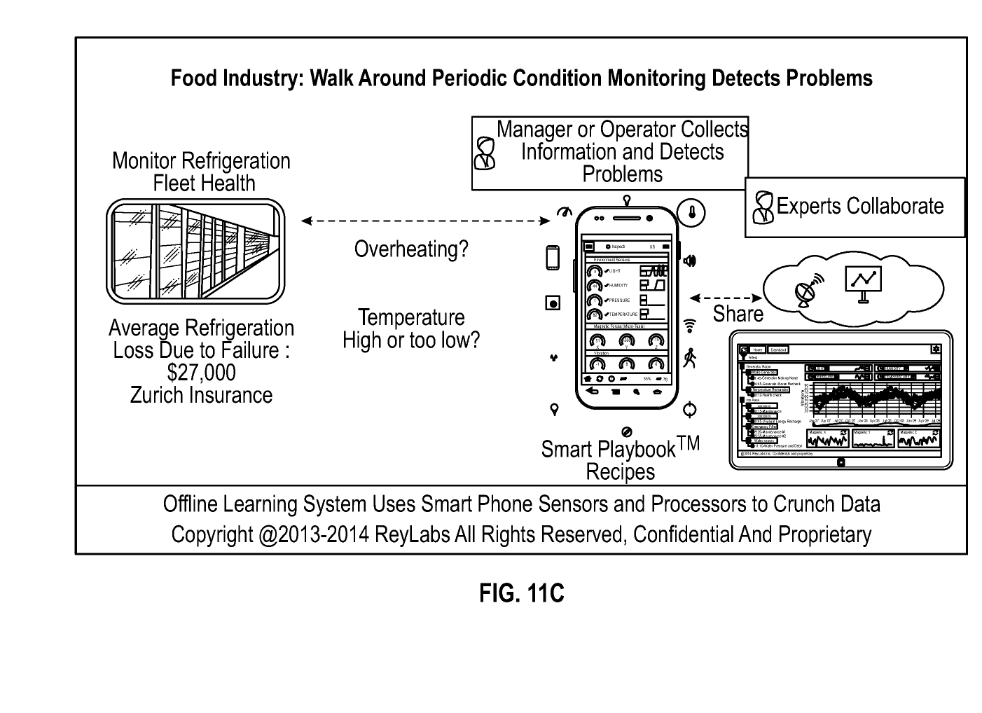

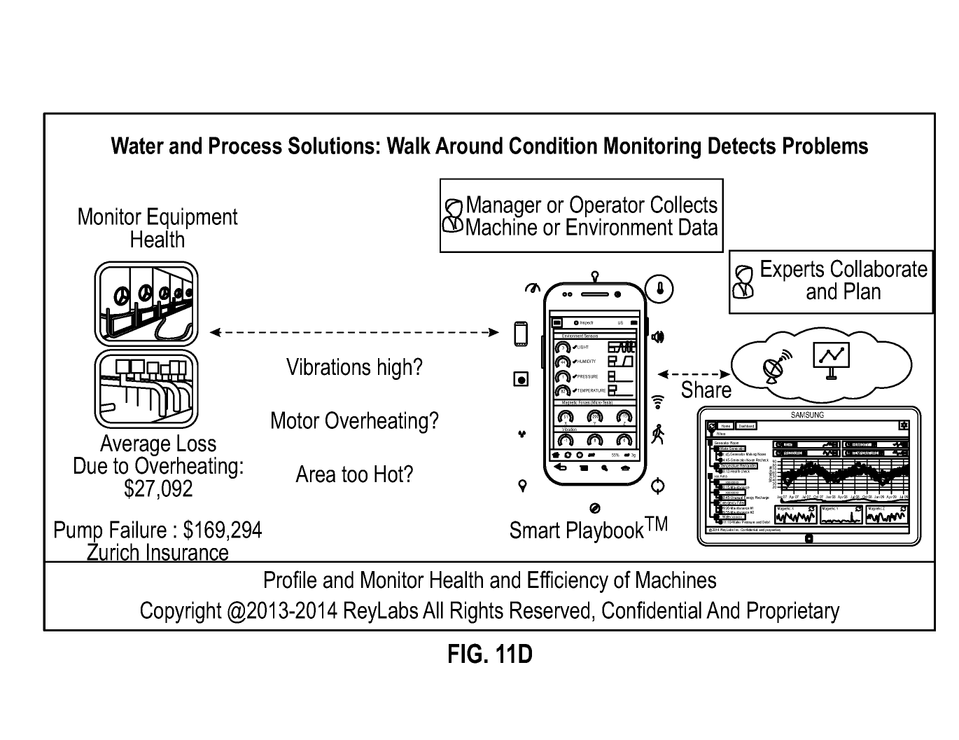

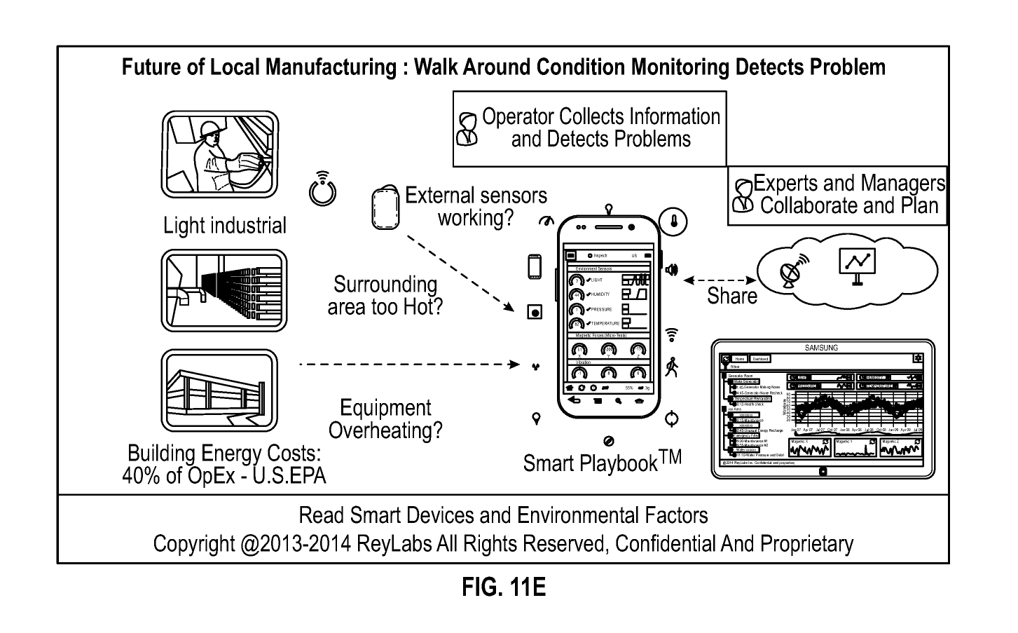

FIGS. 11A-11E are diagrams of mobile analytic engines according to various implementation of the invention.

FIG. 11A describes an overview of the monitoring and predictive maintenance and visualization abilities of some implementations of the present invention using the one-tier, one-node, one-update processing and update cycles.

FIG. 11B illustrates a process for analyzing data 1110 using Playbook recipes/playlists 1100 and sharing 1120 the analytic results using multiple methods similar to consumer game sharing and video sharing scenarios within a safe private network.

FIG. 11C illustrates an exemplary food industry implementation with critical chillers and refrigeration capable of providing contaminated food due to variations in temperature due to external or internal factors.

FIG. 11D illustrates an exemplary water industry implementation where a failing pump may affect an entire water recycling or distribution network.

FIG. 11E illustrates an exemplary manufacturing industry implementation where similar chillers are required to maintain adequate temperature for work machinery and the work machinery overheating may cause excessive energy consumption. These conditions may be detected because we collect and correlate machine and environmental data to determine root cause of problems rather than the current silos of information collected by separate industrial control systems from the building management systems. Many smaller facilities lack either or both of these systems and none of the systems on the market provide predictive analytics but rather focus on controlling a simple operation of a robot or machine.

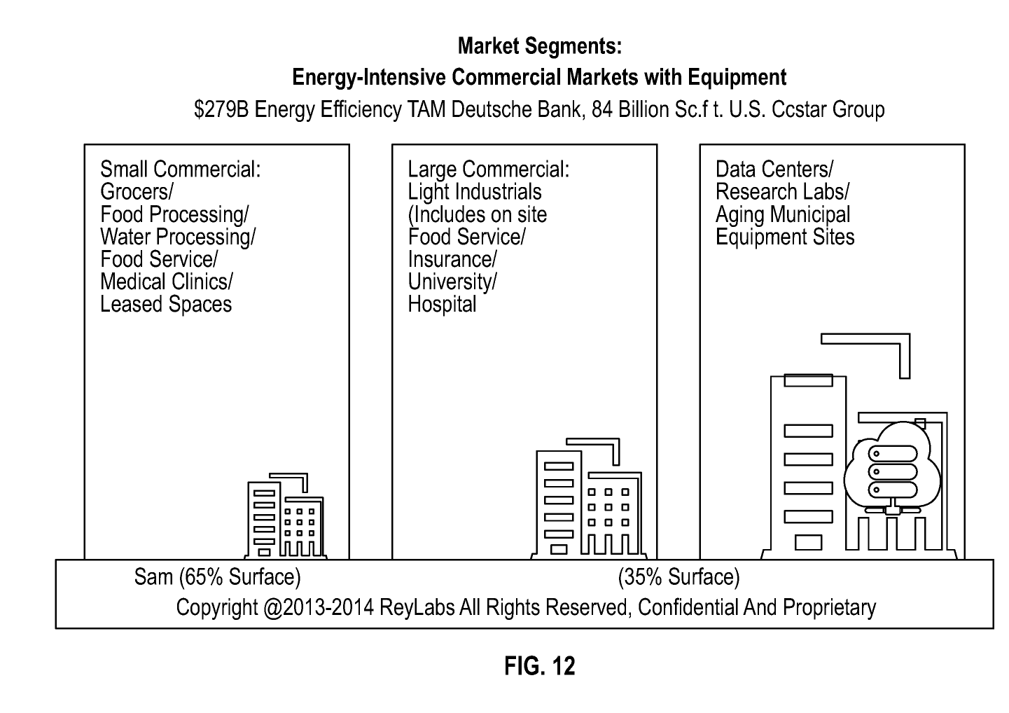

FIG. 12 is a non-limiting diagram of market segments where the invention may be applied.

### Implementations and Other Nuances

The innovations herein may be implemented via one or more components, systems, servers, appliances, other subcomponents, or distributed between such elements. When implemented as a system, such system may comprise, inter alia, components such as software modules, general-purpose CPU, RAM, etc. found in general-purpose computers, and/or FPGAs and/or ASICs found in more specialized computing devices. In implementations where the innovations reside on a server, such a server may comprise components such as CPU, RAM, etc. found in general-purpose computers. Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, appliances, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and other non-transitory media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Other non-transitory media may comprise computer readable instructions, data structures, program modules or other data embodying the functionality herein, in various non-transitory formats. Combinations of the any of the above are also included within the scope of computer readable media. In the present description, the terms component, module, device, etc. may refer to any type of logical or functional circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., Silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the inventions have been specifically described herein, it will be apparent to those skilled in the art to which the inventions pertain that variations and modifications of the various implementations shown and described herein may be made without departing from the spirit and scope of the inventions. Accordingly, it is intended that the inventions be limited only to the extent required by the applicable rules of law.

1. A method, comprising,
sending, via one or more computer processors in communication with a network and data storage, a container of multiple logic dynamic web code instruction sets to a plurality of computing devices via the network, the instruction sets including object direction and analytics instruction for processing data, and the container defining an ordered execution list for the instruction sets;
receiving, with the processor, processed data from each of the plurality of computing devices via the network, the processed data comprising a result of executing the instruction sets according to the execution list;
performing processing, via at least one processor, on the received data; and
aggregating, via at least a processor, the further processed received data;
wherein the sending, receiving, processing, and aggregating provide parallel processing of the data at each of the plurality of computing devices such that each computing device processes only a subset of the aggregated data, and the processor only performs a portion of the total processing of the aggregated data.

2. The method of claim 1, further comprising:
visualizing, with one or more processors, the aggregated further processed received data; and
analyzing, with one or more processors, the aggregated further processed received data.

3. The method of claim 1, further comprising, via at least one processor, allowing arrangement of the processing instructions with html code.

4. The method of claim 1, further comprising, via at least one processor, retrieving, from the plurality of computing devices, ranges of data before or during processing by the plurality of computing devices.

5. The method of claim 1, wherein the container of multiple logic dynamic web code instructions include pattern recognition instructions, and wherein the received processed data includes pattern recognition information.

6. The method of claim 1, wherein the multiple logic dynamic web code instructions are configured for load balancing.

7. The method of claim 1, wherein the multiple logic dynamic web code instructions allow template composition.

8. The method of claim 1, wherein the multiple logic dynamic web code instructions are configured to direct, configure, block, limit, modify, and accelerate inter object demands.

9. The method of claim 1, wherein the container is secured.

10. The method of claim 9, further comprising performing a data flow transformation on the secure container.

11. A method, comprising:
utilizing, with one or more computer processors in communication with a network and data storage, a uniform architecture to collect, aggregate, classify, process, and analyze data;
offloading, with at least one processor, processing instructions to a plurality of computing devices via the network; and
receiving, with at least a processor, processed and analyzed data from the plurality of computing devices in response to the offloading;
wherein the utilizing, offloading, and receiving provide parallel processing of the data at each of the plurality of computing devices such that each computing device processes only a subset of the data, and the processor only performs a portion of the total processing of the data.

12. The method of claim 11, further comprising, via at least one processor, allowing arrangement of the processing instructions with html code.

13. The method of claim 11, further comprising, via at least a processor, retrieving, from the plurality of computing devices, ranges of data before or during processing by a plurality of computing devices in communication via the network.

14. The method of claim 11, wherein the instructions include pattern recognition instructions, and wherein the received processed data includes pattern recognition information.

15. The method of claim 11, wherein the instructions are configured for load balancing.

16. The method of claim 11, wherein the instructions allow template composition.

17. The method of claim 11, wherein the instructions are configured to direct, configure, block, limit, modify, and/or accelerate inter object demands.

18. The method of claim 11, wherein execution of object functions comprises executing commands.

19. A system, comprising,
one or more computer processors in communication with a network and data storage, the one or more computer processors configured to:
send a container of multiple logic dynamic web code instruction sets to a plurality of computing devices via the network, the instruction sets including object direction and analytics instruction for processing data, and the container defining an ordered execution list for the instruction sets;
receive processed data from each of the plurality of computing devices via the network, the processed data comprising a result of executing the instruction sets according to the execution list; and
further process the received processed data;
wherein the sending, receiving, and further processing provide parallel processing of the data at each of the plurality of computing devices such that each computing device processes only a subset of the aggregated data, and the processor only performs a portion of the total processing of the aggregated data.

20. The system of claim 19, wherein the processed data received from the plurality of computing devices comprises partially processed data.
